(19) United States
(12) Patent Application Publication
(10) Pub. No.: US 2024/0327589 A1
(43) Pub. Date: Oct. 3, 2024

(54) Low Odor Heat-Expandable Materials

(71) Applicant: Zephyros, Inc., Romeo, MI (US)

(72) Inventors: Florent Caffy, Molsheim Cedex (FR); Barbara Biechy, Mullhouse (FR); Emilie Jonard, Strasbourg (FR)

(21) Appl. No.: 18/273,849

(22) PCT Filed: Jan. 27, 2022
(86) PCT No.: PCT/EP2022/051880

§ 371 Date: Jul. 24, 2023

(30) Foreign Application Priority Data
Jan. 27, 2021 (EP) 21153716.2

(51) Int. Cl. C08J 9/00; C08J 9/10

(52) U.S. Cl. CPC C08J 9/0066; C08J 9/103; C08J 2203/04; C08J 2323/08; C08J 2333/10; C08J 2363/00; C08J 2423/08; C08J 2433/10

(57) ABSTRACT

The invention relates to the field of structural reinforcement, sealing, damping, baffling, or the like of elements, preferably of hollow structures or cavities, by means of a thermally expandable composition comprising (i) a polymer component; (ii) azodicarbonamide; and (iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis; wherein the weight ratio of the azodicarbonamide to the metal oxide powder is at least about 5.0, preferably at least about 10, more preferably at least about 15, still more preferably at least about 16.50, preferably about 17, and yet more preferably at least about 20; preferably at most about 80; more preferably at most about 70, still more preferably at most about 60, yet more preferably at most about 50, even more preferably at most about 40, most preferably at most about 30. The thermally expandable composition leads to low odor formation and low ammonia emission during and after the foaming process.

Priority is claimed of European patent application no. 21153716.2 that was filed on Jan. 27, 2021.

The invention relates to the field of structural reinforcement, sealing, damping, baffling, or the like of elements, preferably of hollow structures or cavities, by means of a thermally expandable composition comprising (i) a polymer component; (ii) azodicarbonamide; and (iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis; wherein the weight ratio of the azodicarbonamide to the metal oxide powder is at least about 5.0, preferably at least about 10, more preferably at least about 15, still more preferably at least about 16.50, preferably about 17, and yet more preferably at least about 20; preferably at most about 80; more preferably at most about 70, still more preferably at most about 60, yet more preferably at most about 50, even more preferably at most about 40, most preferably at most about 30.

The thermally expandable composition leads to low odor formation and low ammonia emission during and after the foaming process.

Many products of automotive industry, aircraft industry, building industry, construction industry and the like contain hollow structures e.g. for weight reduction. It is often desirable to seal or fill such hollow structures by means of sealing members, baffle elements or other reinforcing elements, e.g. to minimize noise and vibrations, to avoid fumes, dirt, water, humidity, and the like to enter the hollow structures, or to provide mechanical reinforcement while maintaining the advantageous low weight.

Sealing members, baffle elements or other reinforcing elements often comprise a thermoplastic material that is capable of foaming upon activation by heat or any other suitable stimulus. Thus, the thermoplastic material exists in two states, foamable and foamed. Typically, the foamable thermoplastic material becomes a thermoset material after foaming. In the initial foamable state, the material is typically stable at room temperature. Upon heating to its activation temperature, the material undergoes volume expansion due to the activated foaming process thereby yielding the final foamed state of the material. When the foaming process is activated after the material has been placed into the hollow structure, the material expands and finally fills and seals the hollow structure and adheres to its inner walls.

It is common practice to insert the sealing members, baffle elements or other reinforcing elements into the hollow structures during the manufacturing process without prematurely activating the foaming process. The inner walls of the hollow structures are then still accessible to e.g. electro-coating liquids. Afterwards during a heat treatment step, the expandable thermoplastic material expands to fill and seal the hollow structures as intended. Volume expansion by 2500% and more is possible.

In order to enable the foaming process, the materials contain blowing agents (foaming agents).

At elevated temperature or other activation conditions, the blowing agent decomposes and releases gases. This typically goes along with curing of the thermoplastic polymer which is designed to undergo curing at such elevated temperature. A very popular blowing agent is azodicarbonamide (ADCA).

ADCA meets most requirements for blowing agents such as decomposition temperature, gas releasing level, gas composition, ease of dispersion, storage stability and cost. In addition, this ADCA is self-extinguishing in contact with an open flame and does not support burning of the polymer. The decomposition process is complex. Thermal decomposition proceeds in two stages. At the first stage, the decomposition products are carbon monoxide, urea and nitrogen. At the second stage, gaseous ammonia as well as isocyanic acid are formed.

It is known that the ADCA decomposition temperature can be reduced by decomposition initiators such as salts of zinc and calcium. Various potential reaction mechanisms have been discussed in the scientific literature. For example, it has been suggested that the interaction of ADCA with salts of calcium or zinc yields the corresponding salts of azodicarboxylic acid which act as the initiator of thermal decomposition. An acid-base interaction has likewise been proposed where the metal of activating additive acts as a Lewis acid (electron pair acceptor) and ADCA acts as the Lewis base (electron pair donor). According to another hypothesis, metals with filled pre-outer d-electron orbitals can form 7-complexes which include ADCA molecules as ligands. The formation of 7-complexes leads to a decrease in the electron density between nitrogen atoms of the azo-group and carbon and as a result, a break of —C—N═bond is facilitated.

Thermally expandable compositions using azodicarbonamide as a blowing agent can have the disadvantage of odor formation by release of ammonia when exposed to higher temperature. It is thus desirable to obtain a thermally expandable composition containing azodicarbonamide as a blowing agent that does not suffer from these limitations and leads to low odor formation and low ammonia emission during and after the foaming process.

U.S. Pat. No. 4,263,165 relates to a blowing agent combination comprising azodicarbonamide, zinc oxide and a benzenethiol sulphonic acid derivative.

U.S. Pat. Nos. 4,655,962; 4,692,475 relate to a blowing agent composition, comprising: (i) azodicarbonamide; (ii) zinc oxide and/or zinc carbonate; and (iii) at least one member selected from the group consisting of zinc salts of C1-C6 organic acids, and C1-C6 organic carboxamides. The blowing agent composition may be used in effective amounts in formulations containing a foamable polymer to yield an efficiently gas expanded polymeric composition upon exposure to heat.

US 2003 0050352 discloses foamed polymer system that includes a blowing agent performance enhancer to ensure that the foaming rate of the blowing agent is sufficient to achieve the desired foam characteristics and to improve control over the blowing agent performance. The system includes a combination of an azo-type compound with a metallic salt of an organic acid in the manufacture of the foamed polymer.

US 2003 0087976 relates to cross-linked polymeric foam compositions, and methods for making the same. The compositions utilize cross-linked polyolefin copolymers. The polyolefins, which are essentially linear, comprise ethylene polymerized with at least one alpha-unsaturated C3 to C20 olefinic comonomer, and optionally at least one C3 to C20 polyene, and exhibit, in an uncross-linked sense, a resin density in the range of about 0.86 g/cm to about 0.96 g/cm, a melt index in the range of about 0.5 dg/min to about 100 dg/min, a molecular weight distribution in the range of from about 1.5 to about 3.5, and a composition distribution breadth index greater than about 45 percent.

US 2004 0147642 relates to a composition useful for forming a reinforcing body, said composition comprising: from about 20-30% by weight of an SBS block co-polymer; from about 5-20% by weight polystyrene; from about 0.5-5% by weight of a rubber; and from about 30-45% by weight of an epoxy resin. The composition may comprise from about 0.1-5% by weight of a blowing agent and up to about 5% by weight of a compound for lowering the blowing temperature of the composition. Said blowing agent may comprise azodicarbonamide and said compound for lowering the blowing temperature may comprises zinc oxide.

US 2004 0197545 discloses polymer foam articles that are prepared by melt-mixing a polymer composition and a plurality of microspheres.

US 2010 0087558 relates to a filling foam composition that contains a polymer, azodicarbonamide having an average particle size of 10 μm or less, and a zinc compound.

US 2010 0099784 relates to a thermoplastic elastomer foaming material, comprising: a hydrogenated styrenic/conjugated diene copolymer in a range from 5 to 35 weight percent; at least one of an acetate copolymer and an acrylate copolymer in a range from 3 to 30 weight percent; an amorphous polyolefin in a range from 20 to 60 weight percent; and a plasticizer in a range from 10 to 40 weight percent. The material may comprise a foaming agent and a foaming promoter. The foaming agent may be in a range from 1.0 to 10 parts by weight and include azodicarbonamide. The foaming promoter may include a zinc oxide in a range from 0.5 to 6 parts by weight.

US 2016 0009885 relates to a high filling high resilient soft foaming polyethylene material, comprising following parts of raw materials by mass fraction: 15-20 parts of polyethylene, 5-20 parts of elastomers, 60-80 parts of modified calcium carbonate, 1-10 parts of chemical foaming agent, 0.5-1.5 parts of crosslinking agent and 1-5 parts of physical foaming agent. Preferably, the chemical foaming agent is prepared by mixing azodicarbonamide, zinc oxide and zinc stearate with a weight ratio of 1:(1-1.5):(0.15-2).

US 2017 002164 relates to a thermally expandable composition containing an endothermic chemical blowing agent, to shaped bodies containing said composition and to a method for sealing and filling cavities in components, for strengthening or reinforcing components, in particular hollow components, and for bonding movable components using shaped bodies of this type.

US 2019 0276624 relates to a thermally expandable composition, comprising (a) at least one epoxy-functional polymer EP, (b) optionally at least one thermoplastic polymer P, (c) at least one chemical blowing agent B, (d) optionally at least one activator A, wherein said epoxy-functional polymer EP is present in the composition before expansion with an amount of between 30 and 75 wt.-%, based on the total composition, and said epoxy-functional polymer EP comprises at least 300 mmol epoxy groups per kg polymer EP, and wherein said chemical blowing agent B is able to form at least one reaction product with at least two amino groups upon thermal decomposition, and said chemical blowing agent B is present in the composition before expansion with an amount of between 5 and 30 wt.-%, based on the total composition. The blowing agent B may comprise azodicarbonamide. The activator A may comprise zinc oxide and/or an alkylated urea.

EP 1 794 222 relates to a foamable composition that comprises at least about 50 wt % of a co-polymer of ethylene and alkyl (meth)acrylate having a broad chemical composition distribution (CCD), and having a melt index between about 7 and about 30; about 2 to about 40 wt % of a polyolefin having a carboxylic acid or carboxylic acid anhydride functionality; about 1 to about 10 wt % of one or more foaming agents; and about 1 to about 5 wt % of one or more crosslinking agents.

WO 2013 017536 relates to thermally-expandable preparations, containing (a) at least one per-oxide-crosslinkable polymer, (b) at least one low-molecular, multifunctional acrylate, (c) at least one peroxide and (d) at least two different chemical propellants, the mass ratio of the at least one peroxide to the at least one low-molecular, multifunctional acrylate being at least 1:3.

WO 2019 108721 relates to foamed acrylic materials using both traditional blowing agents as well as foamable microspheres.

WO 2019 134842 discloses a thermally expandable composition, comprising at least one polymer P cross-linkable by peroxide, and at least one acrylate, and at least one peroxide, azodicarbonamide and a zinc compound. The thermally expandable composition is said to lead to low odor formation and low ammonia emission during and after the foaming process. Ammonia release is not quantified and odor formation can have sources other than ammonia.

CN 104 277 319 relates to a method for eliminating peculiar smell of an EVA (ethylene-vinyl acetate) foamed material. The foamed system comprises the following core components in parts by weight: 70-100 parts of EVA, 1-20 parts of foaming agent, 0.5-10 parts of foaming crosslinking agent, 1-25 parts of peculiar smell eliminator, 0.5-5 parts of zinc oxide and 0.5-5 parts of stearic acid. The foaming agent is one or more of azobisformamide, azodiisobutyronitrile, dinitrosopentamethylene tetra-mine and 4,4′-oxo-bis-benzenesulfonyl hydrazide. The peculiar smell eliminator is one or more of aluminum tripolyphosphate, aluminum dihydrogen tripolyphosphate, aluminum dihydrogen phosphate, aluminum monohydrogen phosphate and aluminum phosphate. The method eliminates peculiar smell generated in the foaming process to obtain an EVA foamed product.

CN 110 746 709 discloses a cavity filling foamed rubber material for an automobile and a preparation method thereof, and belongs to the technical field of foamed rubber materials. The composition is prepared from the following raw materials in parts by weight: 100 parts of butyl rubber, 70-80 parts of ethylene propylene rubber, 80-100 parts of ethylene-acrylate copolymer, 1-5 parts of stearic acid, 1-5 parts of antioxidant 1010, 90-120 parts of heavy calcium carbonate, 90-100 parts of terpene resin, 80-120 parts of petroleum resin, 90-150 parts of polyisobutylene, 5-20 parts of azodicarbonamide, 1-5 parts of dicyandiamide, 1′-bis(tert-butylperoxy)-3,3,5-trimethylcyclohexane, 1-5 parts of trimethylolpropane trimethacrylate, 5-10 parts of zinc oxide and 0.1-0.5 part of carbon black.

It is an object of the invention to provide thermally expandable compositions containing azodicarbonamide which lead to low odor formation and low ammonia emission during and after the foaming process.

This object has been achieved by the subject-matter of the patent claims.

It has been surprisingly found that by properly adjusting the weight ratio of azodicarbonamide to metal oxide powder, the formation of free ammonia can be significantly reduced thereby suppressing peculiar odor formation.

Further, it has been surprisingly found that the formation of free ammonia can be effectively reduced by providing the catalyst in form of a fine powder that is homogeneously distributed in the composition.

Still further, it has been surprisingly found that the formation of free ammonia can be effectively reduced in presence of a broad variety of polymers that are capable of undergoing curing reactions according to different reaction mechanisms. In particular, it has been surprisingly found that the reduction of ammonia formation does not depend upon the absence or presence of radical polymerization initiators. For example, the advantageous effects of the invention can also be observed in compositions containing reactive epoxy prepolymers that do not require any radical polymerization initiators in order to undergo curing.

Furthermore, it has been surprisingly found that the effect of the weight ratio of azodicarbonamide to catalyst powder is only observed for metal oxides, whereas other metal salts such as zinc stearate or zinc palmitate do not appear to show a corresponding effect.

Moreover, it has been surprisingly found that activation of volume expansion temperatures (i.e.

ADCA decomposition temperatures) may be adjusted by a comparatively low amount of catalyst powder. Pure azodicarbonamide generally reacts around 200° C. Modified azodicarbonamide typically has decomposition temperatures of 165 to 195° C. and this is achieved by additives that accelerate the reaction or react at lower temperatures. The catalyst powder according to the invention is such an additive.

It has now been surprisingly found that comparatively low amounts of metal oxide powder are sufficient in order to reduce the activation of volume expansion temperature of (pure) azodicarbonamide.

While it has been found that increasing the weight ratio of ADCA:metal oxide powder advantageously lowers the amount of release ammonia below the detection limit (the human olfactory thresh-old concentration in air is about 50 ppm), it has further been found that when said ratio exceeds a certain limit, performance of ADCA as blowing agent is deteriorated. An important effect of the metal oxide powder as blowing catalyst is lowering the activation temperature of ADCA. It has been found that when said ratio exceeds a certain limit, ADCA performance is not satisfactory when the composition is subjected to temperatures experienced in the oven used to bake the anticorrosion coating typically applied to the metal frame of an automobile, sometimes known as the “e-coat” process. Thus, a balance needs to be determined between suppression of ammonia release on the one hand and satisfactory performance as blowing agent on the other hand. It has been surprisingly found that an excellent balance is achieved at a weight ratio of ADCA:metal oxide powder within the range of from about 5.0 to 30, preferably from about 16.50, preferably about 17 to 30.

A first aspect of the invention relates to a thermally expandable composition comprising
(i) a polymer component;
   preferably wherein the polymer component comprises a curable polymer; more preferably wherein
   (A) curing of the curable polymer does not involve peroxides and the thermally expandable composition does not contain peroxides, preferably not any polymerization initiators; or
   (B) curing of the curable polymer involves peroxides and the thermally expandable composition contains one or more peroxides; preferably wherein
      (a) the molar ratio of azodicarbonamide to the total content of said one or more peroxides is greater than about 30.0, preferably at least about 30.5, more preferably at least about 31.0, still more preferably at least about 31.5, yet more preferably at least about 32.0; and/or
      (b) the total content of said one or more peroxides is at most about 4.50 wt.-%, more preferably at most about 4.00 wt.-%, still more preferably at most about 3.50 wt.-%, yet more preferably at most 3.00 wt.-%, even more preferably at most 2.75 wt.-%, most preferably at most about 2.50 wt.-%, and in particular at most about 2.25 wt.-%, in each case relative to the total weight of the thermally expandable composition; and/or
      (c) the ratio of the difference value of azodicarbonamide weight content minus metal oxide powder weight content to the peroxide weight content (i.e. ([azodicarbonamide wt.-%]-[metal oxide powder wt.-%])/[peroxide wt.-%], all percentages relative to the total weight of the composition) is at least about 1.85, preferably at least about 2.00, more preferably at least about 2.25, still more preferably at least about 2.50, yet more preferably at least about 2.75, even more preferably at least about 3.00, most preferably at least about 4.00, and in particular at least about 4.25; and/or
      (d) the difference value of the ratio of azodicarbonamide weight content and peroxide weight content minus metal oxide powder weight content (i.e. ([azodicarbonamide wt.-%]/[peroxide wt.-%]) -[metal oxide powder wt.-%], all percentages relative to the total weight of the composition) is at least about 1.75, preferably at least about 2.00, more preferably at least about 2.20, still more preferably at least about 2.40, yet more preferably at least about 2.80, even more preferably at least about 3.20, most preferably at least about 3.60, and in particular at least about 4.00;
(ii) azodicarbonamide; and
(iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis;
   preferably wherein the metal oxide is selected from zinc oxide, magnesium oxide, calcium oxide and mixtures thereof, more preferably zinc oxide; and preferably wherein the content of metal oxide powder is at most about 0.50 wt.-%, relative to the total weight of the thermally expandable composition;

wherein the weight ratio of the azodicarbonamide to the metal oxide powder is at least about 5.0,
preferably at least about 10, more preferably at least about 15, still more preferably at least about 16.50, preferably about 17, and yet more preferably at least about 20;
preferably at most about 80; more preferably at most about 70, still more preferably at most about 60, yet more preferably at most about 50, even more preferably at most about 40, most preferably at most about 30.

Preferably, the thermally expandable composition comprises
(i) a polymer component comprising or essentially consisting of
   (a) an epoxy prepolymer; or
   (b) an olefin acrylate copolymer and/or olefin methacrylate copolymer, an olefin acrylate terpolymer and/or olefin methacrylate terpolymer, an olefin vinylacetate copolymer, or a mixture thereof,
(ii) azodicarbonamide; and
(iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis;

wherein the weight ratio of the azodicarbonamide to the metal oxide powder is at least about 5.0, preferably at least about 10, more preferably at least about 15, still more preferably at least about 16.50, preferably about 17; and at most about 80; preferably at most about 70, more preferably at most about 60, still more preferably at most about 50, even more preferably at most about 40, most preferably at most about 30.

The thermally expandable composition according to the invention is a volume expandable composition. When the composition is heated to an activation of expansion temperature above room temperature, it undergoes volume expansion, as the azodicarbonamide decomposes and thus releases a gas comprising ammonia. The released gas may comprise gases other than ammonia, e.g. carbon monoxide, nitrogen, or isocyanic acid.

Typically, prior to volume expansion, the thermally expandable composition according to the invention is a thermoplastic material which is stable at room temperature (23° C.). The thermoplastic material can typically be reshaped at elevated intermediate temperatures (e.g. in the range of from 80 to 120° C.) and used to produce parts by various polymer processing techniques such as injection molding, compression molding, calendering, extrusion, protrusion, and the like. For example, the thermoplastic material can be applied to substrates at such elevated intermediate temperatures and then cooled to room temperature.

Typically, after volume expansion at elevated higher temperatures (e.g. above 120° C.), the thermally expandable composition according to the invention becomes a thermoset material. The expanded thermoset material does not melt again upon heating, but typically decomposes at elevated very high temperatures and does not reform upon cooling. Thus, after heating to an elevated higher temperature that causes volume expansion, the composition according to the invention typically undergoes transition from a thermoplastic material to a thermoset material. This transition is typically based upon a curing (i.e. crosslinking) reaction that also takes place when the composition is heated to the elevated higher temperature that causes volume expansion. The thermally expandable composition according to the invention is therefore preferably a thermally expandable, thermally curable composition. However, when the thermally expandable composition according to the invention is only heated to an intermediate temperature at which neither volume expansion nor curing is induced, it is thermoplastic and may be formed or shaped, and optionally may be cooled again to room temperature thereby remaining a thermally expandable, thermally curable composition.

The elevated higher temperature that causes volume expansion may be distinguished from the elevated higher temperature that causes curing (crosslinking). In order to capture the gas bubbles that are released upon activation of azodicarbonamide, however, volume expansion and curing preferably at least partially occur simultaneously thereby producing a thermoset foam. By choosing suitable curing agents and curing catalysts (curing accelerators) in suitable amounts, the elevated higher temperature that causes curing (crosslinking) may be properly adjusted relative to the elevated higher temperature that causes volume expansion.

The thermally expandable composition according to the invention preferably is a curable, more preferably a heat curable composition, i.e. a volume expandable and curable composition. Preferably, when the curable composition is heated to an activation of cure temperature, which may be identical with or differ from the activation of expansion temperature, it does not only undergo volume expansion, but additionally undergoes curing (crosslinking). Preferably, curing is heat activated, i.e. preferably the composition already contains all constituents that are necessary for autonomous curing upon heating, i.e. external inductors other than heat, e.g. actinic radiation, are not necessary. Curing of polymers may proceed via various different mechanisms which may also take place simultaneously, e.g. as a free radical reaction, as a sulfur vulcanization, as a polycondensation reaction, as a polyaddition reaction, or via any other mechanism that is suitable for curing.

In preferred embodiments, the weight ratio of the azodicarbonamide to the metal oxide powder is
at least about 7.5, preferably at least about 10, more preferably at least about 12, still more preferably at least about 14, yet more preferably at least about 15, even more preferably at least about 16 or at least about 16.50, most preferably at least about 17, and in particular at least about 18, or at least about 19, or at least about 20;
at most about 80, preferably at most about 75, more preferably at most about 70, still more preferably at most about 65, yet more preferably at most about 60, even more preferably at most about 55, most preferably at most about 50, and in particular at most about 45; in preferred embodiments at most about 44, preferably at most about 43, more preferably at most about 42, still more preferably at most about 41, yet more preferably at most about 40, even more preferably at most about 39, most preferably at most about 38, and in particular at most about 37; in preferred embodiments at most about 36, more preferably at most about 35, still more preferably at most about 34, yet more preferably at most about 33, even more preferably at most about 32, most preferably at most about 31; particularly preferred at most about 30; and/or
within the range of from about 15±10, or 20±15, or 20±10, or 25±20, or 25±15, or 25±10, or 30±25, or 30±20, or 30±15, or 30±10, or 35±30, or 35±25, or 35±20, or 35±15, or 35±10, or 40±35, or 40±30, or 40±25, or 40±20, or 40±15, or 40±10, or 45±40, or 45±35, or 45±30, or 45±25, or 45±20, or 45±15, or 45±10, or 50±45, or 50±40, or 50±35, or 50±30, or 50±25, or 50±20, or 50±15, or 50±10; preferably within the range of from at least about 5.0 to at most about 50, more preferably within the range of from at least about 5.0 to at most about 30, still more preferably within the range of from at least about 16.50, preferably about 17 to at most about 30.

In preferred embodiments, the weight ratio of the azodicarbonamide to the metal oxide powder, preferably zinc oxide, is within the range of from about 16.50, preferably about 17 to 32.50, preferably about 16.50, preferably about 17 to 32.00; more preferably about 16.50, preferably about 17 to 30.

In other preferred embodiments, the weight ratio of the azodicarbonamide to the metal oxide powder, preferably zinc oxide, is within the range of from about 32.50 to 83.50.

The thermally expandable composition according to the invention comprises a powder of a metal oxide. Metal oxides are known to the skilled person. A powder typically is a dry, bulk solid composed of many very fine particles that may flow freely when shaken or tilted. Preferably, the metal oxide powder is homogenously distributed in the thermally expandable composition, thereby catalyzing the thermal decomposition of azodicarbonamide. Exemplary metal oxide powders are sold under the tradename INNOVOX SG, commercially available from Birch Chemicals, or under the tradename Extra R.

In a preferred embodiment, at least about 90 wt.-% of particles within the metal oxide powder have a particle size of at most about 100 μm, preferably at most about 50 μm, more preferably at most about 25 μm, still more preferably at most about 10 μm, and yet more preferably at most about 5 μm; determined by sieve analysis, preferably according to ASTM B214-16.

In a preferred embodiment, the weight content of the metal oxide powder is
at least about 0.03 wt.-%, preferably at least about 0.04 wt.-%, more preferably at least about 0.05 wt.-%, still more preferably at least about 0.06 wt.-%, yet more preferably at least about 0.07 wt.-%, even more preferably at least about 0.08 wt.-%, most preferably at least about 0.09 wt.-%, and in particular at least about 0.1 wt.-%;
at most about 1.0 wt.-%, preferably at most about 0.8 wt.-%, more preferably at most about 0.6 wt.-%, still more preferably at most about 0.5 wt.-%, yet more preferably at most about 0.4 wt.-%, even more preferably at most about 0.3 wt.-%, most preferably at most about 0.2 wt.-%, and in particular at most about 0.1 wt.-%; and/or
within the range of from about 0.15±0.1 wt.-%, or 0.25±0.2 wt.-%, or 0.25±0.1 wt.-%, or 0.35±0.3 wt.-%, or 0.35±0.2 wt.-%, or 0.35±0.1 wt.-%, or 0.45±0.4 wt.-%, or 0.45±0.3 wt.-%, or 0.45±0.2 wt.-%, or 0.45±0.1 wt.-%, or 0.55±0.5 wt.-%, or 0.55±0.4 wt.-%, or 0.55±0.3 wt.-%, or 0.55±0.2 wt.-%, or 0.55±0.1 wt.-%, or 0.65±0.6 wt.-%, or 0.65±0.5 wt.-%, or 0.65±0.4 wt.-%, or 0.65±0.3 wt.-%, or 0.65±0.2 wt.-%, or 0.65±0.1 wt.-%, or 0.75±0.7 wt.-%, or 0.75±0.5 wt.-%, or 0.75±0.4 wt.-%, or 0.75±0.3 wt.-%, or 0.75±0.2 wt.-%, or 0.75±0.1 wt.-%;
in each case relative to the total weight of the thermally expandable composition.

In a preferred embodiment, the metal oxide powder is crystalline, amorphous or partially crystalline.

In a preferred embodiment, the metal oxide is selected from zinc oxide, magnesium oxide, calcium oxide, iron oxide and mixtures thereof.

In a preferred embodiment, the metal oxide powder is zinc oxide and wherein the weight ratio of the azodicarbonamide to the zinc oxide is
at least about 7.5, preferably at least about 10, more preferably at least about 12, still more preferably at least about 14, yet more preferably at least about 15, even more preferably at least about 16, most preferably at least about 17, and in particular at least about 18;
at most about 80, preferably at most about 75, more preferably at most about 70, still more preferably at most about 65, yet more preferably at most about 60, even more preferably at most about 55, most preferably at most about 50, and in particular at most about 45; and/or
within the range of from about 10±5.0, or 15±10, or 15±5.0, or 20±15, or 20±10, or 20±5.0, or 25±20, or 25±15, or 25±10, or 25±5.0, or 30±25, or 30±20, or 30±15, or 30±10, or 30±5.0, or 35±30, or 35±25, or 35±20, or 35±15, or 35±10, or 35±5.0, or 40±35, or 40±30, or 40±25, or 40±20, or 40±15, or 40±10, or 40±5.0.

Preferably, at least about 90 wt.-% of particles within the metal oxide powder have a particle size of at most about 100 μm, preferably at most about 50 μm, more preferably at most about 25 μm, still more preferably at most about 10 μm, yet more preferably at most about 5 μm, and even more preferably at most about 2 μm; determined by sieve analysis.

In a preferred embodiment, the metal oxide powder is magnesium oxide and wherein weight ratio of the azodicarbonamide to the magnesium oxide is
at least about 6.0, preferably at least about 7.0, more preferably at least about 8.0, still more preferably at least about 9.0, yet more preferably at least about 10, even more preferably at least about 12, most preferably at least about 15, and in particular at least about 18;
at most about 80, preferably at most about 75, more preferably at most about 70, still more preferably at most about 65, yet more preferably at most about 60, even more preferably at most about 55, most preferably at most about 50, and in particular at most about 45; and/or
within the range of from about 5±2.5, or 7.5±5, or 7.5±2.5, or 10±7.5, or 10±5.0, or 10±2.5, or 15±10, or 15±7.5, or 15±5.0, or 15±2.5, or 20±15, or 20±10, or 20±5.0, or 25±20, or 25±15, or 25±10, or 25±5.0, or 30±25, or 30±20, or 30±15, or 30±10, or 30±5.0, or 35±30, or 35±25, or 35±20, or 35±15, or 35±10, or 35±5.0, or 40±35, or 40±30, or 40±25, or 40±20, or 40±15, or 40±10, or 40±5.0.

Preferably, at least about 90 wt.-% of particles within the metal oxide powder have a particle size of at most about 100 μm, preferably at most about 50 μm, more preferably at most about 25 μm, still more preferably at most about 15 μm; determined by sieve analysis.

In a preferred embodiment, the metal oxide powder is calcium oxide and wherein weight ratio of the azodicarbonamide to the calcium oxide is
at least about 7.5, preferably at least about 10, more preferably at least about 12, still more preferably at least about 14, yet more preferably at least about 15, even more preferably at least about 16, most preferably at least about 17, and in particular at least about 18;
at most about 80, preferably at most about 75, more preferably at most about 70, still more preferably at most about 65, yet more preferably at most about 60, even more preferably at most about 55, most preferably at most about 50, and in particular at most about 45;
within the range of from about 10±5.0, or 15±10, or 15±5.0, or 20±15, or 20±10, or 20±5.0, or 25±20, or 25±15, or 25±10, or 25±5.0, or 30±25, or 30±20, or 30±15, or 30±10, or 30±5.0, or 35±30, or 35±25, or 35±20, or 35±15, or 35±10, or 35±5.0, or 40±35, or 40±30, or 40±25, or 40±20, or 40±15, or 40±10, or 40±5.0.

Preferably, at least about 90 wt.-% of particles within the metal oxide powder have a particle size of at most about 100 μm, preferably at most about 50 μm, more preferably at most about 40 μm; determined by sieve analysis.

In a preferred embodiment, the weight content of the azodicarbonamide is
at least about 0.5 wt.-%, preferably at least about 1.0 wt.-%, more preferably at least about 1.5 wt.-%, still more preferably at least about 2.0 wt.-%, yet more preferably at least about 2.5 wt.-%, even more preferably at least about 3.0 wt.-%, most preferably at least about 3.5 wt.-%, and in particular at least about 4.0 wt.-%;
at most about 16 wt.-%, preferably at most about 15 wt.-%, more preferably at most about 14 wt.-%, still more preferably at most about 13 wt.-%, yet more preferably at most about 12 wt.-%, even more preferably at most about 11 wt.-%, most preferably at most about 10 wt.-%, and in particular at most about 9.0 wt.-%; and/or
within the range of from about 3.0±2.0 wt.-%, or 4.0±3.0 wt.-%, or 4.0±2.0 wt.-%, or 5.0±4.0 wt.-%, or 5.0±3.0 wt.-%, or 5.0±2.0 wt.-%, or 6.0±5.0 wt.-%, or 6.0±4.0 wt.-%, or 6.0±3.0 wt.-%, or 6.0±2.0 wt.-%, or 7.0±6.0 wt.-%, or 7.0±5.0 wt.-%, or 7.0±4.0 wt.-%, or 7.0±3.0 wt.-%, or 7.0±2.0 wt.-%, or 8.0±7.0 wt.-%, or 8.0±6.0 wt.-%, or 8.0±5.0 wt.-%, or 8.0±4.0 wt.-%, or 8.0±3.0 wt.-%, or 8.0±2.0 wt.-%, or 9.0±8.0 wt.-%, or 9.0±7.0 wt.-%, or 9.0±6.0 wt.-%, or 9.0±5.0 wt.-%, or 9.0±4.0 wt.-%, or 9.0±3.0 wt.-%, or 9.0±2.0 wt.-%;
in each case relative to the total weight of the thermally expandable composition.

The thermally expandable composition according to the invention comprises a polymer component comprising at least one polymer. For the purpose of the specification, “polymer component” refers to a polymeric material comprising one or more polymers. The term “polymer component” is synonymous to the expression “one or more polymers”. As the thermally expandable composition according to the invention may comprise more than a single polymer, unless expressly stated otherwise, all polymers that are contained in the thermally expandable composition according to the invention are commonly referred to as “polymer component”. Thus, unless expressly stated otherwise, all amounts and percent-ages referring to the “polymer component” refer to the total quantity of all polymers that are contained in the thermally expandable composition according to the invention. However, when besides the polymer component additional reference is made to a polymeric ingredient such as a polymeric curing agent or a polymeric filler, the quantity of said polymeric ingredient is separate from the quantity of the polymer(s) forming the “polymer component”.

A polymer is composed of macromolecules (https://goldbook.iupac.org/terms/view/P04735), i.e. molecules of high relative molecular mass, the structure of which essentially comprises the multiple repetition of units derived, actually or conceptually, from molecules of low relative molecular mass. A polymer may also be a system of monomers that have been reacted to an intermediate molecular mass state (polymer precursor or prepolymer). Thus, the term “polymer component” also encompasses any prepolymers of intermediate molecular mass state, which e.g. are typically intended to react to polymers of higher molecular mass e.g. by curing (cross-linking) with a suitable curing agent. A polymer may further be derived from more than one species of monomer, thereby building a copolymer which consists of at least two types of constituent units (also structural units, bipolymer, terpolymer, and the like).

Preferably, the polymer component according to the invention comprises a polymer blend, i.e. a mixture of different polymers, which preferably differ from one another in molecular weight, melt flow index, and/or chemical nature, e.g. relative content of comonomer units or chemical nature of monomer units. In case of the presence of two or more polymers, all weights and percentages refer to the total weight of all polymers that are contained in the polymer component.

Prior to volume expansion of the thermally expandable composition according to the invention, the polymer component comprises or essentially consists of a curable polymer, a non-curable polymer, a crosslinked polymer, a non-crosslinked polymer, or any mixture thereof. A curable polymer (cross-linkable polymer) is typically capable of further polymerization through reactive groups to a cured high molecular weight state. A non-curable polymer typically cannot be further polymerized by crosslinking the macromolecules. A crosslinked polymer is typically already at least partially crosslinked and may or may not be additionally curable. The macromolecules of a non-crosslinked polymer are typically not previously further crosslinked and may either be curable or non-curable. Thus, according to the invention, a curable polymer can be either already crosslinked or non-crosslinked.

In a preferred embodiment, prior to volume expansion of the thermally expandable composition according to the invention, the polymer component comprises or essentially consists of an optionally crosslinked polymer that is further curable, i.e. the polymer component is a curable polymer component.

In this embodiment, upon heating to an activation of expansion temperature, the composition preferably undergoes not only volume expansion, but additionally curing, i.e. the macromolecules are further crosslinked. Curing of the curable polymer component may proceed via various different mechanisms which may also take place simultaneously, e.g. as a free radical reaction, as a sulfur vulcanization, as a polycondensation reaction, as a polyaddition reaction, or via any other mechanism that is suitable for curing.

In another preferred embodiment, prior to volume expansion of the thermally expandable composition according to the invention, the polymer component comprises or essentially consists of an optionally crosslinked polymer that is not further curable. In this embodiment when the composition is heated to an activation of expansion temperature and undergoes volume expansion, it is not cured, i.e. the macromolecules are not further crosslinked.

Preferably, the polymer component is curable, i.e. capable of being cured, preferably by cross-linking involving a reaction between the curable polymer and a curing agent. Preferably, such crosslinking is induced thermally, i.e. preferably the thermally expandable composition already contains all constituents that are necessary for autonomous curing upon heating, such that external inductors other than heat, e.g. actinic radiation, are not necessary.

Suitable polymers, preferably suitable curable polymers, are known to the skilled person and may vary depending upon the intended use of the thermally expandable composition according to the invention, i.e. structural adhesives, structural foams, noise reducing foams, cavity fillers, sealants, and the like.

Suitable polymers include but are not limited to epoxy prepolymers, polyolefins (e.g., polyethylene, polypropylene), polystyrene, polyacrylates, polybutylacrylates, poly(ethylene oxides), poly(ethyleneimines), polyesters, polyurethanes, polysiloxanes, polyethers, polyphosphazines, polyamides, polyimides, polyisobutylenes, polyacrylonitriles, poly(vinyl chlorides), poly(methyl methacrylates), poly(vinyl acetates), olefin acrylate copolymers and/or olefin methacrylate copolymers, olefin acrylate terpolymers and/or olefin methacrylate terpolymers, olefin vinylacetate copolymers, poly(vinylidene chlorides), polytetrafluoroethylenes, polyisoprenes, polyacrylamides, polyacrylic acids, polymethacrylates, their mixtures and/or copolymers.

In particularly preferred embodiments, the polymer component comprises or essentially consists of
(a) an epoxy prepolymer; or
(b) an olefin acrylate copolymer and/or olefin methacrylate copolymer, an olefin acrylate terpolymer and/or olefin methacrylate terpolymer, an olefin vinylacetate copolymer, or a mixture thereof.

A skilled person recognizes that curing (crosslinking) of the curable polymer can be achieved by different mechanisms, depending upon the chemical nature of the curable polymer and a compatible curing agent. Curing can be based upon a free radical mechanism, a condensation reaction, an addition reaction, sulfur vulcanization, and the like.

The curing should be induced at a temperature at which the formulation will flow and is preferably induced at temperatures above about 110° C., more preferably at temperatures of at least about 165° C., most preferably at a temperature in the range of from about 130° C. to about 220° C., preferably from about 150° C. to about 220° C. such as the temperatures experienced in the automotive anticorrosion coat (known as e-coat) bake oven.

Preferably, the polymer component comprises a curable polymer (e.g. polyolefin, epoxy prepolymer, acrylate prepolymer or monomer, urethane prepolymer, or elastomer). Depending upon its application, e.g. as structural adhesive, structural foam, noise reducing foam, cavity filler or sealant, the thermally expandable composition may comprise additional constituents, such as tackifyers, impact modifiers, flexibilizers, fillers, and the like.

When the thermally expandable composition is a noise reducing foam, cavity filler or sealant, the polymer component preferably comprises a curable polyolefin and the curing agent is one that is capable of reacting with the polyolefin thereby providing a crosslinked polyolefinic resin. According to this embodiment, peroxides may be added as radical initiators optionally together with coagents (curing accelerators) in order to induce radical crosslinking upon activation at elevated temperature. Alternatively, curing of the curable polyolefin may be achieved by any other known curing system such as sulfur curing.

When the thermally expandable composition is a structural adhesive or structural foam, the polymer component preferably comprises a curable epoxy prepolymer and the curing agent is one that is capable of reacting with the epoxy prepolymer thereby providing a crosslinked epoxy resin.

In a preferred embodiment, the weight content of the polymer component is
at least about 36 wt.-%, preferably at least about 38 wt.-%, more preferably at least about 40 wt.-%, still more preferably at least about 42 wt.-%, yet more preferably at least about 44 wt.-%, even more preferably at least about 46 wt.-%, most preferably at least about 48 wt.-%, and in particular at least about 50 wt.-%;
at most about 74 wt.-%, preferably at most about 72 wt.-%, more preferably at most about 70 wt.-%, still more preferably at most about 68 wt.-%, yet more preferably at most about 66 wt.-%, even more preferably at most about 64 wt.-%, most preferably at most about 62 wt.-%, and in particular at most about 60 wt.-%; and/or
within the range of from about 30±10 wt.-%, or 35±15 wt.-%, or 35±10 wt.-%, or 40±20 wt.-%, or 40±15 wt.-%, or 40±10 wt.-%, or 45±25 wt.-%, or 45±20 wt.-%, or 45±15 wt.-%, or 45±10 wt.-%, or 50±30 wt.-%, or 50±25 wt.-%, or 50±20 wt.-%, or 50±15 wt.-%, or 50±10 wt.-%, or 55±35 wt.-%, or 55±30 wt.-%, or 55±25 wt.-%, or 55±20 wt.-%, or 55±15 wt.-%, or 55±10 wt.-%, or 60±30 wt.-%, or 60±25 wt.-%, or 60±20 wt.-%, or 60±15 wt.-%, or 60±10 wt.-%, or 65±25 wt.-%, or 65±20 wt.-%, or 65±15 wt.-%, or 65±10 wt.-%;
in each case relative to the total weight of the thermally expandable composition.

In preferred embodiments, the thermally expandable composition according to the invention does not contain peroxides. According to these embodiments, the polymer component preferably comprises a curable polymer whereas curing of said curable polymer does not involve peroxides (e.g. as polymerization initiators).

In a preferred embodiment, particularly when the thermally expandable composition is a structural adhesive or a structural foam, the polymer component preferably comprises an epoxy prepolymer, i.e. a material that comprises reactive epoxy functional groups. The polymer component includes the epoxy prepolymer in order to form a desirable thermally expandable composition that can later be activated to cure (for the purpose of the specification also abbreviated as “epoxy”).

The epoxy prepolymer may be any dimeric, oligomeric or polymeric epoxy materials containing at least one epoxy functional group, i.e. a reactive oxirane moiety. Moreover, the term epoxy prepolymer can be used to denote one epoxy prepolymer or a combination of multiple epoxy prepolymers. The epoxy prepolymers may be epoxy-containing materials having one or more oxirane rings polymerizable by a ring opening reaction.

In a preferred embodiment, the polymer component comprises or essentially consists of an epoxy prepolymer.

In a preferred embodiment, the polymer component comprises or essentially consists of a mixture of one or more solid epoxy prepolymers with one or more liquid epoxy prepolymers.

The epoxy prepolymer may include an ethylene copolymer or terpolymer that may possess an alpha olefin. The epoxy may include a phenolic resin, which may be a novolac type (e.g., an epoxy phenol novolac, an epoxy cresol novolac, combinations thereof, or the like) or other type resin. Other preferred epoxy prepolymers includes a bisphenol-A epichlorohydrin ether polymer, or a bisphenol-A epoxy prepolymer which may be modified with butadiene or another polymeric additive. In a preferred embodiment, the epoxy prepolymer is a diglycidylether of a bisphenol, such as bisphenol-A, bisphenol-F, or the like. Moreover, various mixtures of several different epoxy prepolymers may be employed as well. Examples of suitable epoxy prepolymers are sold under the trade name Epokukdo® (e.g. Epokukdo KD-214C, Epokukdo KD-242G, Epokukdo YD-128), commercially available from Kukdo Chemicals.

Preferably, the weight content of the polymer component comprising or essentially consisting of an epoxy prepolymer is
at least about 26 wt.-%, preferably at least about 28 wt.-%, more preferably at least about 30 wt.-%, still more preferably at least about 32 wt.-%, yet more preferably at least about 34 wt.-%, even more preferably at least about 36 wt.-%, most preferably at least about 38 wt.-%, and in particular at least about 40 wt.-%;
at most about at most about 74 wt.-%, preferably at most about 72 wt.-%, more preferably at most about 70 wt.-%, still more preferably at most about 68 wt.-%, yet more preferably at most about 66 wt.-%, even more preferably at most about 64 wt.-%, most preferably at most about 62 wt.-%, and in particular at most about 60 wt.-%; and/or
within the range of from about 25±10 wt.-%, 30±15 wt.-%, 30±10 wt.-%, 35±20 wt.-%, or 35±15 wt.-%, or 35±10 wt.-%, or 40±25 wt.-%, or 40±20 wt.-%, or 40±15 wt.-%, or 40±10 wt.-%, or 45±30 wt.-%, or 45±25 wt.-%, or 45±20 wt.-%, or 45±15 wt.-%, or 45±10 wt.-%, or 50±35 wt.-%, or 50±30 wt.-%, or 50±25 wt.-%, or 50±20 wt.-%, or 50±15 wt.-%, or 50±10 wt.-%, or 55±35 wt.-%, or 55±30 wt.-%, or 55±25 wt.-%, or 55±20 wt.-%, or 55±15 wt.-%, or 55±10 wt.-%;
in each case relative to the total weight of the thermally expandable composition.

When the polymer component according to the invention comprises more than a single epoxy prepolymer, the above contents preferably apply to the overall (total) content of epoxy prepolymer, relative to the total weight of the thermally expandable composition.

When the polymer component comprises an epoxy prepolymer as curable polymer, it preferably also comprises one or more curing agents and/or curing agent accelerators for the epoxy prepolymer.

Amounts of curing agents and curing agent accelerators may vary within the thermally expandable composition depending upon the type of cure required and crosslink density desired and the desired structural properties of the cured thermally expandable composition. Preferably, the curing agent is a latent curing agent, i.e. is not reactive under ambient conditions but is heat activatable. Preferably, the curing agent contains functional groups that are capable of reacting with epoxy groups of an epoxy prepolymer at an elevated activation of cure temperature. Preferably, the curing agent has an activation of cure temperature above about 110° C., more preferably in the range of from about 130° C. to about 220° C., preferably about 150° C. to about 220° C.

The thermally expandable composition according to the invention comprises a curing agent for the epoxy prepolymer; preferably selected from the group consisting of dicyandiamide, aliphatic or aromatic amines or their respective adducts, amidoamines, polyamides, cycloaliphatic amines, anhydrides, polycarboxylic polyesters, isocyanates, phenol-based resins (preferably selected from phenol or cresol novolac resins, copolymers of phenol terpene, polyvinyl phenol, or bisphenol-A formaldehyde copolymers, bishydroxyphenyl alkanes), modified and unmodified polyamines or polyamides (preferably selected from triethylenetetramine, diethylenetriamine tetraethylenepentamine, and cyanoguanidine); preferably dicyandiamide.

In a preferred embodiment, the weight content of the curing agent for the epoxy prepolymer component is
at least about 0.1 wt.-%, preferably at least about 0.2 wt.-%, more preferably at least about 0.4 wt.-%, still more preferably at least about 0.6 wt.-%, yet more preferably at least about 0.8 wt.-%, even more preferably at least about 1.0 wt.-%, most preferably at least about 1.2 wt.-%, and in particular at least about 1.4 wt.-%;
at most about 6.0 wt.-%, preferably at most about 5.5 wt.-%, more preferably at most about 5.0 wt.-%, still more preferably at most about 4.5 wt.-%, yet more preferably at most about 4.0 wt.-%, even more preferably at most about 3.5 wt.-%, most preferably at most about 3.0 wt.-%, and in particular at most about 2.5 wt.-%; and/or
within the range of from about 0.8+0.2 wt.-%, or 1.0±0.4 wt.-%, or 1.2+0.6 wt.-%, or 1.4+0.8 wt.-%, or 1.6+1.0 wt.-%, or 1.8+1.2 wt.-%, or 2.0±1.4 wt.-%, or 2.2+1.6 wt.-%;
in each case relative to the total weight of the thermally expandable composition.

An accelerator for these curing agents (e.g., a modified or unmodified urea such as methylene diphenyl bis urea, an imidazole or a combination thereof) may also be provided.

The polymer component may also include one or more additional polymer and/or copolymer materials, such as thermoplastics, elastomers, plastomers, combinations thereof or the like.

Preferably, the thermally expandable composition comprising a polymer component comprising or essentially consisting of an epoxy prepolymer exhibits a volume expansion at 190° C. of
at least about 160 vol.-%, preferably at least about 200 vol.-%, more preferably at least about 240 vol.-%, still more preferably at least about 280 vol.-%, yet more preferably at least about 320 vol.-%, even more preferably at least about 360 vol.-%, most preferably at least about 400 vol.-%, and in particular at least about 440 vol.-%;
at most about 1240 vol.-%, preferably at most about 1190 vol.-%, more preferably at most about 1140 vol.-%, still more preferably at most about 1090 vol.-%, yet more preferably at most about 1040 vol.-%, even more preferably at most about 990 vol.-%, most preferably at most about 940 vol.-%, and in particular at most about 890 vol.-%; and/or
within the range of from about 100±50 vol.-%, or 200±100 vol.-%, or 400±200 vol.-%, or about 600±200 vol.-%, or 800±400 vol.-%, or 800±200 vol.-%, or 1000±600 vol.-%, or 1000±400 vol.-%, or 1000±200 vol.-%, or 1200±800 vol.-%, or 1200±600 vol.-%, or 1200±400 vol.-%, or 1200±200 vol.-%, or 1400±1000 vol.-%, or 1400±800 vol.-%, or 1400±600 vol.-%, or 1400±400 vol.-%, or 1400±200 vol.-%, or 1600±1200 vol.-%, or 1600±1000 vol.-%, or 1600±800 vol.-%, or 1600±600 vol.-%, or 1600±400 vol.-%, or 1600±200 vol.-%;
in each case relative to the volume of the expandable composition prior to expansion.

In a particularly preferred embodiment of the invention, particularly when the thermally expandable composition is a structural adhesive or a structural foam, the thermally expandable composition comprises or essentially consists of
an epoxy prepolymer as defined above;
a curing agent for the epoxy prepolymer as defined above;
metal oxide powder as defined above,
azodicarbonamide;
optionally, accelerator as defined above;
optionally, filler; and
optionally, impact modifier.

In a particularly preferred embodiment of the invention, particularly when the thermally expandable composition is a structural adhesive or a structural foam, the thermally expandable composition comprises, in each case relative to the total weight of the thermally expandable composition,
(i) 20 to 50 wt.-%, preferably 25 to 45 wt.-% of a polymer component comprising or essentially consisting of an epoxy prepolymer; preferably a diglycidylether of a bisphenol; preferably a mixture of one or more solid epoxy prepolymers with one or more liquid epoxy prepolymers;
(ii) 0.5 to 10 wt.-%, preferably 1.0 to 5.0 wt.-% azodicarbonamide;
(iii) 0.01 to 2.0 wt.-%, preferably 0.03 to 1.0 wt.-%, more preferably 0.03 to 0.15 wt.-% metal oxide powder; preferably selected from zinc oxide, magnesium oxide, calcium oxide, iron oxide and mixtures thereof, more preferably zinc oxide;
(iv) 0.1 to 5.0 wt.-%, preferably 0.6 to 3.5 wt.-% of a curing agent for the epoxy prepolymer; preferably selected from the group consisting of dicyandiamide, aliphatic or aromatic amines or their respective adducts, amidoamines, polyamides, cycloaliphatic amines, anhydrides, polycarboxylic polyesters, isocyanates, phenol-based resins, modified and unmodified poly-amines or polyamides; more preferably dicyandiamide;
(v) optionally, 21 to 61 wt.-%, preferably 31 to 51 wt.-% of at least one filler; preferably selected from carbonates, calcium carbonate, feldspars, micas, quartz, silica, diatomaceous earth, vermiculite, pyrophyllite, sauconite, saponite, nontronite, montmorillonite, glass, clay, talc, ammonium chloride, dimethyl ammonium chloride, dimethyl benzyl ammonium chloride, titanium dioxide, pigments, colorants, glass beads or bubbles, glass, carbon or ceramic fibers, nylon aramid or polyamide fibers, and mixtures thereof, and
(vi) optionally, 4.0 to 30 wt.-% of an impact modifier; preferably a polymer/elastomer adduct; more preferably a carboxyl terminated butadiene acrylonitrile rubber (CTBN)-epoxy adduct;
wherein the weight ratio of the azodicarbonamide to the metal oxide powder is at least about 5.0 and at most about 80; preferably at least about 5.0 and at most about 70; more preferably at least about 5.0 and at most about 30; still more preferably at least about 16.50, preferably about 17 and at most about 30.

In a preferred embodiment, particularly when the thermally expandable composition is a noise reducing foam, cavity filler or sealant, the polymer component comprises a polyolefin, olefin acrylate copolymer and/or olefin methacrylate copolymer, olefin acrylate terpolymer and/or olefin methacrylate terpolymer, olefin vinylacetate copolymer, olefin elastomers or mixture thereof, for the purpose of the specification commonly encompassed by and referred to as “polyolefins”.

Preferably, the polymer component comprises or essentially consists of a mixture of one or more olefin vinylacetate copolymers with one or more olefin acrylate copolymers and/or olefin methacrylate copolymers, optionally together with one or more olefin acrylate terpolymers and/or olefin methacrylate terpolymers.

In a preferred embodiment,
the olefin vinylacetate copolymers are independently of one another selected from ethylene vinyl acetate copolymers (E/VA), which may be optionally grafted with maleic anhydride (MAH), i.e. E/VA/MAH;
the olefin acrylate copolymers and/or olefin methacrylate copolymers are independently of one another selected from ethylene alkyl acrylate copolymers and ethylene alkyl methacrylate copolymers, wherein the alkyl group in the alkyl acrylate and the alkyl methacrylate, respectively, is preferably selected from methyl, ethyl, propyl, and butyl; preferably selected from the group consisting of ethylene methyl acrylate copolymers (E/MA), ethylene ethyl acrylate copolymers (E/EA), ethylene propyl acrylate copolymers (E/PA), ethylene butyl acrylate copolymers (E/BA), ethylene methyl methacrylate copolymers (E/MMA), ethylene ethyl methacrylate copolymers (E/EMA), ethylene propyl methacrylate copolymers (E/PMA), and ethylene butyl methacrylate copolymers (E/BMA); more preferably ethylene methyl acrylate copolymers (E/MA) or ethylene butyl acrylate copolymers (E/BA), whereas in each case the acrylate content and/or methacrylate content is preferably within the range of from about 20 to 35%;
the olefin acrylate terpolymers and/or olefin methacrylate terpolymers are terpolymers of ethylene and alkyl acrylate, or ethylene and alkyl methacrylate, in each case with glycidyl acrylate (GA) or glycidyl methacrylate (GMA), wherein the alkyl group in the alkyl acrylate and the alkyl methacrylate, respectively, is preferably selected from methyl, ethyl, propyl, and butyl; preferably selected from the group consisting of ethylene methyl acrylate glycidyl acrylate terpolymers (E/MA/GA), ethylene ethyl acrylate glycidyl acrylate terpolymers (E/EA/GA), ethylene propyl acrylate glycidyl acrylate terpolymers (E/PA/GA), ethylene butyl acrylate glycidyl acrylate terpolymers (E/BA/GA), ethylene methyl methacrylate glycidyl acrylate terpolymers (E/MMA/GA), ethylene ethyl methacrylate glycidyl acrylate terpolymers (E/EMA/GA), ethylene propyl methacrylate glycidyl acrylate terpolymers (E/PMA/GA), ethylene butyl methacrylate glycidyl acrylate terpolymers (E/BMA/GA), ethylene methyl acrylate glycidyl methacrylate terpolymers (E/MA/GMA), ethylene ethyl acrylate glycidyl methacrylate terpolymers (E/EA/GMA), ethylene propyl acrylate glycidyl methacrylate terpolymers (E/PA/GMA), ethylene butyl acrylate glycidyl methacrylate terpolymers (E/BA/GMA), ethylene methyl methacrylate glycidyl methacrylate terpolymers (E/MMA/GMA), ethylene ethyl methacrylate glycidyl methacrylate terpolymers (E/EMA/GMA), ethylene propyl methacrylate glycidyl methacrylate terpolymers (E/PMA/GMA), ethylene butyl methacrylate glycidyl methacrylate terpolymers (E/BMA/GMA); more preferably ethylene methyl acrylate glycidyl methacrylate terpolymers (E/MA/GMA) or ethylene butyl acrylate glycidyl methacrylate terpolymers (E/BA/GMA); whereas in each case the acrylate content and/or methacrylate content is preferably within the range of from about 20 to about 35%.

In preferred embodiments, the polymer component comprises one or more olefin acrylate copolymers and/or olefin methacrylate copolymers (bipolymers) and the content of the one or more olefin acrylate copolymers and/or olefin methacrylate copolymers is at least about 12 wt.-%, preferably at least about 15 wt.-%, more preferably at least about 18 wt.-%, still more preferably at least about 21 wt.-%, yet more preferably at least about 24 wt.-%, even more preferably at least about 27 wt.-%, most preferably at least about 30 wt.-%, and in particular at least about 33 wt.-%; in each case relative to the total weight of the thermally expandable composition and in each case based upon the total content of the one or more olefin acrylate copolymers and/or olefin methacrylate copolymers.

Preferably, the weight content of the polymer component comprising or essentially consisting of the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof, is
at least about 30 wt.-%, preferably at least about 34 wt.-%, more preferably at least about 38 wt.-%, still more preferably at least about 42 wt.-%, yet more preferably at least about 46 wt.-%, even more preferably at least about 50 wt.-%, most preferably at least about 54 wt.-%, and in particular at least about 58 wt.-%;
at most about 84 wt.-%, preferably at most about 82 wt.-%, more preferably at most about 80 wt.-%, still more preferably at most about 78 wt.-%, yet more preferably at most about 76 wt.-%, even more preferably at most about 74 wt.-%, most preferably at most about 72 wt.-%, and in particular at most about 70 wt.-%; and/or
within the range of from about 30 10 wt.-%, or 35±15 wt.-%, or 35±10 wt.-%, or 40±20 wt.-%, or 40±15 wt.-%, or 40±10 wt.-%, or 45±25 wt.-%, or 45±20 wt.-%, or 45±15 wt.-%, or 45±10 wt.-%, or 50±30 wt.-%, or 50±25 wt.-%, or 50±20 wt.-%, or 50±15 wt.-%, or 50±10 wt.-%, or 55±35 wt.-%, or 55±30 wt.-%, or 55±25 wt.-%, or 55±20 wt.-%, or 55±15 wt.-%, or 55±10 wt.-%, or 60±40 wt.-%, or 60±35 wt.-%, or 60±30 wt.-%, or 60±25 wt.-%, or 60±20 wt.-%, or 60±15 wt.-%, or 60±10 wt.-%;
in each case relative to the total weight of the thermally expandable composition.

As far as the above polyolefins, olefin acrylate copolymers and/or olefin methacrylate copolymers, olefin acrylate terpolymers and/or olefin methacrylate terpolymers, olefin vinylacetate copolymers, olefin elastomers or mixtures thereof are concerned, the thermally expandable composition may comprise a curing system. There are two main curing systems for polyolefins, e.g. for ethylene copolymers, namely sulfur curing systems and peroxides curing systems. Sulfur cure is typically limited to polyolefins with carbon-to-carbon double bonds, like ethylene propylene diene monomer rubber (EPDM). Peroxide can typically cure polyolefins with or without carbon-to-carbon double bonds, like ethylene vinyl acetate copolymers (EVA). Peroxide cured polyolefins are typically stronger, more durable, and more expensive than sulfur cured polyolefins. Peroxide cured foams are predominantly closed-celled (when compressed, the cells of the foam deform). Sulfur cured foams are predominantly open-celled (when compressed, the gas flows out of the cells). So peroxide cured foams tend to absorb less water, another advantage for most automotive applications.

In a preferred embodiment, the polymer component according to the invention comprises a curable polymer, preferably a curable polyolefin, and a polymerization initiator which includes one or more peroxides, optionally in combination with one or more curing agents for crosslink formation by peroxides (curing accelerators). Under these circumstances, curing relies on a free radical mechanism. Deciding which system is optimal for a given application depends on the required curing conditions, the polymer or polymer blend employed, and the desired physical properties of the finally cured thermally expandable composition.

Suitable polymerization initiators preferably have cure temperatures in the range of from about 120° C. to about 220° C., preferably from about 150° C. to about 200° C., i.e. in the range of the preferred activation of cure temperature. Preferred polymerization initiators include peroxides but are not limited to n-butyl 4,4 bis t-butyl peroxy valerate (4,4-di-tert-butyl peroxy n-butyl valerate), dibenzoyl peroxide, 2,5-dimethyl-2,5-bis(tert-butyl peroxy) hexane, 2,5-dimethyl-2,5-bis(tert-butyl peroxy) hexyne-3, di-tert-butyl peroxide, tert-butyl cumyl peroxide, dicumyl peroxide, bis(tert-butyl peroxy isopropyl)benzene, and 1,1-di-tert-butyl peroxy-3,3,5-trimethylcyclohexane; especially preferred is n-butyl 4,4 bis t-butyl peroxy valerate.

Preferably, the weight content of the polymerization initiator (e.g. peroxide) is
at least about 0.4 wt.-%, preferably at least about 0.6 wt.-%, more preferably at least about 0.8 wt.-%, still more preferably at least about 1.0 wt.-%, yet more preferably at least about 1.2 wt.-%, even more preferably at least about 1.4 wt.-%, most preferably at least about 1.6 wt.-%, and in particular at least about 1.7 wt.-%;
at most about 6.0 wt.-%, preferably at most about 5.5 wt.-%, more preferably at most about 5.0 wt.-%, still more preferably at most about 4.5 wt.-%, yet more preferably at most about 4.0 wt.-%, even more preferably at most about 3.5 wt.-%, most preferably at most about 3.0 wt.-%, or at most about 2.75 wt.-%, and in particular at most about 2.5 wt.-%; and/or
within the range of from about 1.2+0.6 wt.-%, or 1.4+0.8 wt.-%, or 1.6+1.0 wt.-%, or 1.8+1.2 wt.-%, or 2.0±1.4 wt.-%, or 2.2+1.6 wt.-%; or within the range of from about 1.2+0.6 wt.-%, or 1.4+0.8 wt.-%, or 1.6+1.0 wt.-%, or 1.8+1.0 wt.-%, or 2.0±0.8 wt.-%, or 2.2+0.6 wt.-%; in each case relative to the total weight of the thermally expandable composition.

Preferably, the total content of one or more peroxides is at most about 4.50 wt.-%, more preferably at most about 4.00 wt.-%, still more preferably at most about 3.50 wt.-%, yet more preferably at most 3.00 wt.-%, even more preferably at most 2.75 wt.-%, most preferably at most about 2.50 wt.-%, and in particular at most about 2.25 wt.-%, in each case relative to the total weight of the thermally expandable composition.

The basic chemistry of peroxide decomposition and subsequent crosslink-forming reactions is well established for the various unsaturated and saturated polymer systems and typically include desirable reactions which lead to effective crosslink formation and undesirable, competing reactions which detract from productive use of radicals. The balance between productive and competing nonproductive reactions depends on many factors and according to the invention may be tipped toward productive crosslink formation through the use of curing agents for crosslink formation by peroxides, i.e. very reactive, multifunctional coagent compounds. Curing agents for crosslink formation by peroxides preferably favor network formation through increased local concentrations of easily-abstractable hydrogens, e.g. allylic hydrogens, or other very reactive sites of unsaturation.

In a preferred embodiment, the thermally expandable composition comprises a curing agent for the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof, preferably selected from
(i) multifunctional acrylate and methacrylate esters; preferably dipentaerythritol pentaacrylate, pentaerythritol tetraacrylate, ethylene glycol diacrylate, ethylene glycol dimethacrylate, 1,3-butylene glycol dimethacrylate, diallyl maleate, allyl methacrylate, trimethylolpropane dimethacrylate, trimethylolpropane triacrylate, trimethylolpropane trimethacrylate, octyl/decyl acrylate, or 1,6-hexanediol diacrylate, more preferably dipentaerythritol pentaacrylate; and
(ii)allyl containing cyanurates and isocyanurates; preferably triallyl cyanurate or triallyl isocyanurate.

Preferably, the weight content of the curing agent for the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof is
at least about 0.15 wt.-%, preferably at least about 0.20 wt.-%, more preferably at least about 0.25 wt.-%, still more preferably at least about 0.30 wt.-%, yet more preferably at least about 0.35 wt.-%, even more preferably at least about 0.40 wt.-%, most preferably at least about 0.45 wt.-%, and in particular at least about 0.50 wt.-%;
at most about 1.3 wt.-%, preferably at most about 1.2 wt.-%, more preferably at most about 1.1 wt.-%, still more preferably at most about 1.0 wt.-%, yet more preferably at most about 0.9 wt.-%, even more preferably at most about 0.8 wt.-%, most preferably at most about 0.7 wt.-%, and in particular at most about 0.6 wt.-%; and/or
within the range of from about 0.1+0.05 wt.-%, or 0.2+0.1 wt.-%, 0.3+0.15 wt.-%, or 0.4+0.2 wt.-%, or 0.5±0.25 wt.-%, or 0.6+0.3 wt.-%;
in each case relative to the total weight of the thermally expandable composition.

Polymers that are curable by means of the above one or more polymerization initiators, optionally in combination with one or more of the above curing agents for crosslink formation by peroxides, are known to the skilled person and include but are not limited to
polyolefins, olefin acrylate copolymers and/or olefin methacrylate copolymers, olefin acrylate terpolymers and/or olefin methacrylate terpolymers, olefin vinylacetate copolymers or mixtures thereof,
polyolefin elastomers and other elastomers such as natural rubber, polyisoprene, polybutadiene copolymers, styrene butadiene rubber, acrylonitrile butadiene rubber, hydrogenated butadiene acrylonitrile rubber, polychloroprene, polyurethane, hypalon, chlorinated polyethylene, ethylene-propylene co- and terpolymers, silicone, bromobutyl rubber, fluor rubber, and polyethylene.

Preferably, the thermally expandable composition comprising a polymer component comprising or essentially consisting of the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof, exhibits a volume expansion at 190° C. of
at least about 650 vol.-%, preferably at least about 700 vol.-%, more preferably at least about 750 vol.-%, still more preferably at least about 800 vol.-%, yet more preferably at least about 850 vol.-%, even more preferably at least about 900 vol.-%, most preferably at least about 950 vol.-%, and in particular at least about 1000 vol.-%;
at most about 2750 vol.-%, preferably at most about 2700 vol.-%, more preferably at most about 2650 vol.-%, still more preferably at most about 2600 vol.-%, yet more preferably at most about 2550 vol.-%, even more preferably at most about 2500 vol.-%, most preferably at most about 2450 vol.-%, and in particular at most about 2400 vol.-%; and/or
within the range of from about 100±50 vol.-%, or 200±100 vol.-%, or 400±200 vol.-%, or about 600±200 vol.-%, or 800±400 vol.-%, or 800±200 vol.-%, or 1000±600 vol.-%, or 1000±400 vol.-%, or 1000±200 vol.-%, or 1200±800 vol.-%, or 1200±600 vol.-%, or 1200±400 vol.-%, or 1200±200 vol.-%, or 1400±1000 vol.-%, or 1400±800 vol.-%, or 1400±600 vol.-%, or 1400±400 vol.-%, or 1400±200 vol.-%, or 1600±1200 vol.-%, or 1600±1000 vol.-%, or 1600±800 vol.-%, or 1600±600 vol.-%, or 1600±400 vol.-%, or 1600±200 vol.-%;
in each case relative to the volume ofthe expandable composition prior to expansion.

In a particularly preferred embodiment of the invention, particularly when the thermally expandable composition is a noise reducing foam, cavity filler or sealant, the thermally expandable composition comprises or essentially consists of
one or more polyolefins, olefin acrylate copolymers and/or olefin methacrylate copolymers, olefin acrylate terpolymers and/or olefin methacrylate terpolymers, olefin vinylacetate copolymers, olefin elastomers or mixtures thereof, as defined above;
a polymerization initiator as defined above;
a curing agent for the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof, as defined above;
metal oxide powder as defined above,
azodicarbonamide;
optionally, filler; and
optionally, tackifier.

In another preferred embodiment, the polymer component comprises or essentially consists of an acrylate prepolymer or monomer.

Preferably, the acrylate monomer is or the acrylate prepolymer is derived from (meth)acrylic acid, (meth)acrylic acid esters, or mixtures thereof, optionally in combination with one or more radically polymerizable monomers.

In another preferred embodiment, the polymer component comprises or essentially consists of an urethane prepolymer.

Curing of the thermally expandable composition according to the invention may principally be activated by different stimuli. Suitable stimuli include, but are not limited to, heat, actinic radiation, humidity, or the mixing of the two components of a two-component system with one another so that they can undergo spontaneous reaction. Preferably, curing is activated by heat, preferably at an elevated temperature that is similar to the elevated temperature that activates volume expansion by decomposition and resultant gas release of azodicarbonamide.

The thermally expandable composition may also include one or more fillers, including but not limited to particulated materials (e.g., powder), beads, microspheres, or the like. Fillers can be useful to reduce any blocking tendency of the thermally expandable composition, reduce cost, and reduce the coefficient of thermal expansion of the cured material.

In a preferred embodiment, the thermally expandable composition comprises at least one filler.

Preferably, the filler is selected from carbonates, calcium carbonate, feldspars, micas, quartz, silica, diatomaceous earth, vermiculite, pyrophyllite, sauconite, saponite, nontronite, montmorillonite, glass, clay (preferably selected from kaolinite, illite, chloritem, smecitite or sepiolite groups, which may be calcined), talc, ammonium chloride, dimethyl ammonium chloride, dimethyl benzyl ammonium chloride, titanium dioxide, pigments, colorants, glass beads or bubbles, glass, carbon or ceramic fibers, nylon aramid or polyamide fibers.

Preferably, the weight content of the filler is
at least about 6.0 wt.-%, preferably at least about 7.0 wt.-%, more preferably at least about 8.0 wt.-%, still more preferably at least about 9.0 wt.-%, yet more preferably at least about 10 wt.-%, even more preferably at least about 11 wt.-%, most preferably at least about 12 wt.-%, and in particular at least about 13 wt.-%;
at most about at most about 80 wt.-%, preferably at most about 75 wt.-%, more preferably at most about 70 wt.-%, still more preferably at most about 65 wt.-%, yet more preferably at most about 60 wt.-%, even more preferably at most about 55 wt.-%, most preferably at most about 50 wt.-%, and in particular at most about 45 wt.-%; and/or
within the range of about 16+5.0 wt.-%, or 21 10 wt.-%, or 21+5.0 wt.-%, or 26±15 wt.-%, or 26 10 wt.-%, 26+5.0 wt.-%, or 31+20 wt.-%, or 31+15 wt.-%, or 31+10 wt.-%, 31+5.0 wt.-%, or 36+25 wt.-%, or 36±20 wt.-%, or 36±15 wt.-%, or 36±10 wt.-%, 36±5.0 wt.-%, or 41±30 wt.-%, or 41±25 wt.-%, or 41±20 wt.-%, or 41±15 wt.-%, or 41±10 wt.-%, 41±5.0 wt.-%;
in each case relative to the total weight of the composition.

In another preferred embodiment, the polymer component comprises or essentially consists of an elastomer or rubber.

In a preferred embodiment, the polymer component comprises a combination of
one or more elastomers and
one or more polymers, preferably curable polymers, selected from epoxy prepolymers, polyolefins, olefin acrylate copolymers and/or olefin methacrylate copolymers, olefin acrylate terpolymers and/or olefin methacrylate terpolymers, olefin vinylacetate copolymers, olefin elastomers, acrylate prepolymers or monomers, urethane prepolymers and mixtures thereof.

Preferably, the elastomer is selected from the group consisting of natural rubber, polyisoprene, polyisobutylene, polybutadiene, isoprene-butadiene copolymer, neoprene, styrene butadiene rubber, nitrile rubber, butyl rubber, acrylic elastomer, acrylonitrile butadiene rubber, hydrogenated butadiene acrylonitrile rubber, polychloroprene, hypalon, chlorinated polyethylene, chlorosulphonated polyethylene, ethylene-propylene co- and terpolymers, diisocyanate-linked condensation elastomer, silicone rubber, polysiloxane, polyester rubber, polysulfide elastomer, bromobutyl rubber, fluor rubber, polyethylene, and combinations thereof.

The thermally expandable composition may include one or more tackifiers (e.g., tackifying resins), which may be added to the composition for enhancing adhesion, peel strength or both. The tackifier may be a hydrocarbon based tackifier such as an aromatically modified C5 or C5 C9 hydrocarbon tackifying resin or an aliphatic resin. When included, the tackifying resin is up to about 25 wt.-% of the composition. The tackifier may comprise from about 2 wt.-% to about 20 wt.-%, preferably from about 5 wt.-% to about 15 wt.-% of the composition. Exemplary tackifiers are sold under the tradename WINGTACK, commercially available from Goodyear Chemical, under the tradename HIKOTACK P-110S, commercially available from Kolon Industries, or under the tradename Escorez® 5690, commercially available from Exxon Mobil Corporation.

The thermally expandable composition may include one or more impact modifiers. Various impact modifiers may be employed in the practice of the invention and often include one or more elastomers. The impact modifier may be at least about 4 wt.-%, at least about 7 wt.-%, at least about 10 wt.-%, at least about 13 wt.-% and even still more typically at least about 16 wt.-% of the thermally expandable composition. The impact modifier may be less than about 90 wt.-%, less than about 40 wt.-% or even less than about 30 wt.-% of the thermally expandable composition.

Preferably, the impact modifier is selected from elastomer/epoxy adducts, core/shell materials, and combinations thereof.

While it is contemplated that various polymer/elastomer adducts may be employed in the thermally expandable composition used in the invention, one preferred adduct is an epoxy/elastomer adduct.

The epoxy/elastomer hybrid or adduct may be included in an amount of from about 5 wt.-% to about 80 wt.-% of formulation, typically about 10 wt.-% to about 60 wt.-%, more preferably is about 10 wt.-% to about 30 wt.-% of the thermally expandable composition (the elastomer/epoxy adduct is then to be regarded as being separate from the epoxy prepolymer, i.e. the epoxy prepolymer does not encompass the elastomer/epoxy adduct). The elastomer-containing adduct may be a combination of two or more particular adducts and the adducts may be solid adducts or liquid adducts at a temperature of about 23° C. or may also be combinations thereof. The adduct is preferably one or more adducts that are solid at a temperature of about 23° C.

The adduct itself generally includes about 1:8 to 3:1 parts of epoxy or other polymer to elastomer, and more preferably about 1:5 to 1:6 parts of epoxy to elastomer. More typically, the adduct includes at least about 5 wt.-%, more typically at least about 12 wt.-% and even more typically at least about 18 wt.-% elastomer and also typically includes not greater than about 50 wt.-%, even more typically no greater than about 40 wt.-% and still more typically no greater than about 35 wt.-% elastomer, although higher or lower percentages are possible. The elastomer compound may be a thermosetting elastomer. Exemplary elastomers include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. Examples of preferred epoxy/elastomer adducts are sold under the trade name HYPOX commercially available from CVC Chemical, or under the trade name LSA01. Examples of additional or alternative epoxy/elastomer or other adducts suitable for use in the invention are disclosed in US 2004/0204551.

The elastomer-containing adduct, when added to the thermally expandable composition material, may modify structural properties of the thermally expandable composition such as strength, tough-ness, stiffness, flexural modulus, or the like.

The thermally expandable according to the invention may include one or more additives (e.g., functional additives) for improving one or more various properties of the composition. As examples, additives may include antioxidants, antiozonants, ultraviolet absorbers, ultraviolet resistant agents, lubricants, antistatic agents, colorants, flame retardants, heat stabilizers, plasticizers, preservatives, processing aids, stabilizers, or combinations thereof, or the like.

The thermally expandable composition according to the invention is a one-component system or a two-component system.

In a preferred embodiment, the thermally expandable composition according to the invention is dry to the touch and/or non-tacky to the touch at room temperature (23° C.). Preferably, the thermally expandable composition according to the invention becomes adhesive at elevated temperature. Preferably, when being heated to the activation of expansion temperature, the thermally expandable composition according to the invention exhibits adhesive properties.

In another, less preferred embodiment, the thermally expandable composition according to the invention is tacky to the touch at room temperature (23° C.).

Preferably, the thermally expandable composition according to the invention is selected from structural adhesives, structural foams, noise reducing foams, cavity fillers and sealants. Depending upon the specific application, the thermally expandable composition may comprise conventional constituents, additives, auxiliaries and the like that are typically added to compositions devoted for said specific application.

Representative structural adhesives and structural foams and their typical constituents are described e.g. in US 2008/0143143, US 2008/0257491, US 2011/0156443, US 2011/0192015, US 2011/0220267, US 2012/0028032, US 2012/0146296, US 2012/0205029, US 2012/0235401, US 2013/0056153, US 2013/0206333, and US 2014/0113983, which are incorporated herein by reference.

Representative noise reducing foams, cavity fillers and sealants and their typical constituents are described e.g. in US 2007/0193171, US 2008/0265516, US 2009/0202294, US 2012/0201627, US 2013/0232896, US 2014/0169861, US 2015/0147472, and US 2015/0158282, which are incorporated herein by reference.

Preferably, the thermally expandable composition according to the invention at the activation of expansion temperature or above, e.g. at about 190° C., undergoes volume expansion in a range from about 50 vol.-% up to about 2500 vol.-%, depending upon the application of the thermally expandable composition. For structural adhesives and structural foams, volume expansion is preferably within the range of from about 50 vol.-% to about 200 vol.-%. For noise reducing foams, cavity fillers and sealants, volume expansion is preferably higher, e.g. preferably at least about 200 vol.-%, or at least about 400 vol.-%, or at least about 600 vol.-%, or at least about 800 vol.-%, or at least about 1000 vol.-%, or at least about 1500 vol.-%, or at least about 2000 vol.-%, relative to the volume of the thermally expandable composition before it was heated to the activation of expansion temperature. Subject to preliminary routine experiments, the volume expansion of the thermally expandable composition can be adjusted by the total amount of the blowing component (azodicarbonamide).

In a preferred embodiment, the thermally expandable composition exhibits a volume expansion at the activation of expansion temperature or above, e.g. at about 190° C., of
at least about 160 vol.-%, preferably at least about 200 vol.-%, more preferably at least about 240 vol.-%, still more preferably at least about 280 vol.-%, yet more preferably at least about 320 vol.-%, even more preferably at least about 360 vol.-%, most preferably at least about 400 vol.-%, and in particular at least about 440 vol.-%;
at most about 2750 vol.-%, preferably at most about 2700 vol.-%, more preferably at most about 2650 vol.-%, still more preferably at most about 2600 vol.-%, yet more preferably at most about 2550 vol.-%, even more preferably at most about 2500 vol.-%, most preferably at most about 2450 vol.-%, and in particular at most about 2400 vol.-%; and/or
within the range of from about 100±50 vol.-%, or 200±100 vol.-%, or 400±200 vol.-%, or about 600±200 vol.-%, or 800±400 vol.-%, or 800±200 vol.-%, or 1000±600 vol.-%, or 1000±400 vol.-%, or 1000±200 vol.-%, or 1200±800 vol.-%, or 1200±600 vol.-%, or 1200±400 vol.-%, or 1200±200 vol.-%, or 1400±1000 vol.-%, or 1400±800 vol.-%, or 1400±600 vol.-%, or 1400±400 vol.-%, or 1400±200 vol.-%, or 1600±1200 vol.-%, or 1600±1000 vol.-%, or 1600±800 vol.-%, or 1600±600 vol.-%, or 1600±400 vol.-%, or 1600±200 vol.-%;
in each case relative to the volume of the expandable composition prior to expansion.

Preferably, the thermally expandable composition according to the invention has an activation of expansion temperature of at least about 100° C., more preferably at least about 120° C., still more preferably at least about 140° C. Preferably, the activation of expansion temperature is below 250° C.

Preferably, the activation of expansion temperature is within the range of temperatures experienced in the automotive anticorrosion coating bake oven. Typically, activation of expansion temperatures are in the range of from about 150° C. to about 220° C. Therefore, very high temperatures at which the thermally expandable composition would undergo pyrolysis, e.g. 600° C. or 1200° C., are not to be regarded as activation of expansion temperature within the meaning according to the invention.

Likewise, when the thermally expandable composition according to the invention is curable, it preferably has an activation of cure temperature of at least about 100° C., more preferably at least about 120° C., still more preferably at least about 140° C. Preferably, the activation of cure temperature is below 250° C. Preferably, the activation of cure temperature is within the range of temperatures experienced in the automotive anticorrosion coating bake oven. Typically, activation of cure temperatures are in the range of from about 150° C. to about 220° C. Therefore, very high temperatures at which the thermally expandable composition would undergo pyrolysis, e.g. 600° C. or 1200° C., are not to be regarded as activation of cure temperature within the meaning according to the invention.

In a preferred embodiment the thermally expandable composition according to the invention does not comprise
31.10 wt.-% ethylene vinylacetate copolymer resin (18 wt.-% vinylacetate monomer and a melt flow index (MFI) of 150 g/10 min (ASTM D1238)),
18.13 wt.-% ethylene-vinylacetate copolymer resin (28 wt.-% vinyl acetate monomer and a MFI of 6 g/10 min),
14.44 wt.-% ethylene glycidyl methacrylate copolymer (8.0 wt.-% glycidyl methacrylate and a MFI of 5 g/10 min),
6.17 wt.-% C5:C9-hydrocarbon resin (Mn 1100 g/mol, Mw 2000 g/mol),
0.10 wt.-% zinc oxide,
5.60 wt.-% polyethylene wax (melting point 118° C. (ASTM D3954)),
0.62 wt.-% stabilizer (Irganox 1010),
10.28 wt.-% calcium carbonate,
8.39 wt.-% azodicarbonamide,
4.61 wt.-% bis(2-tert-butyl peroxy isopropyl)benzene (40 wt.-%) on calcium carbonate and silica, and
0.56 wt.-% dipentaerythritol pentaacrylate.

More preferably, the thermally expandable composition according to the invention does not comprise
31.10 wt.-% of a first ethylene vinylacetate copolymer resin,
18.13 wt.-% of a second ethylene-vinylacetate copolymer resin,
14.44 wt.-% ethylene glycidyl methacrylate copolymer,
6.17 wt.-% C5:C9-hydrocarbon resin,
0.10 wt.-% metal oxide,
5.60 wt.-% polyethylene wax,
0.62 wt.-% stabilizer,
10.28 wt.-% filler,
8.39 wt.-% azodicarbonamide,
4.61 wt.-% bis(2-tert-butyl peroxy isopropyl)benzene, and
0.56 wt.-% dipentaerythritol pentaacrylate.

Still more preferably, the thermally expandable composition according to the invention does not have a weight ratio of the azodicarbonamide to the zinc oxide of 83.90.

In a preferred embodiment the thermally expandable composition according to the invention does not comprise
31.05 wt.-% ethylene vinylacetate copolymer resin (18 wt.-% vinylacetate monomer and a melt flow index (MFI) of 150 g/10 min (ASTM D1238)),
18.11 wt.-% ethylene-vinylacetate copolymer resin (28 wt.-% vinyl acetate monomer and a MFI of 6 g/10 min),
14.42 wt.-% ethylene glycidyl methacrylate copolymer (8.0 wt.-% glycidyl methacrylate and a MFI of 5 g/10 min),
6.16 wt.-% C5:C9-hydrocarbon resin (Mn 1100 g/mol, Mw 2000 g/mol),
0.26 wt.-% zinc oxide,
5.59 wt.-% polyethylene wax (melting point 118° C. (ASTM D3954)),
0.62 wt.-% stabilizer (Irganox 1010),
10.26 wt.-% calcium carbonate,
8.38 wt.-% azodicarbonamide,
4.60 wt.-% bis(2-tert-butyl peroxy isopropyl)benzene (40 wt.-%) on calcium carbonate and silica, and
0.55 wt.-% dipentaerythritol pentaacrylate.

More preferably, the thermally expandable composition according to the invention does not comprise
31.05 wt.-% of a first ethylene vinylacetate copolymer resin,
18.11 wt.-% of a second ethylene-vinylacetate copolymer resin,
14.42 wt.-% ethylene glycidyl methacrylate copolymer,
6.16 wt.-% C5:C9-hydrocarbon resin,
0.26 wt.-% metal oxide,
5.59 wt.-% polyethylene wax,
0.62 wt.-% stabilizer,
10.26 wt.-% filler,
8.38 wt.-% azodicarbonamide,
4.60 wt.-% bis(2-tert-butyl peroxy isopropyl)benzene, and
0.55 wt.-% dipentaerythritol pentaacrylate.

Still more preferably, the thermally expandable composition according to the invention does not have a weight ratio of the azodicarbonamide to the zinc oxide of 32.23.

In preferred embodiments, the thermally expandable composition according to the invention comprises a metal oxide powder which comprises or essentially consists of a metal oxide selected from the group consisting of zinc oxide, magnesium oxide, calcium oxide, iron oxide and mixtures thereof.

In other preferred embodiments, the thermally expandable composition according to the invention comprises a metal oxide powder which neither is nor comprises zinc oxide, wherein the metal oxide powder preferably comprises or essentially consists of a metal oxide selected from the group consisting of magnesium oxide, calcium oxide, iron oxide and mixtures thereof.

In other preferred embodiments, the metal oxide powder comprises or essentially consists of zinc oxide.

In preferred embodiments, the polymer component comprises one or more polymers, preferably curable polymers, selected from the group consisting of epoxy prepolymers, polyolefins, olefin acrylate copolymers and/or olefin methacrylate copolymers, olefin acrylate terpolymers and/or olefin methacrylate terpolymers, olefin vinylacetate copolymers, olefin elastomers, acrylate prepolymers or monomers, urethane prepolymers and mixtures thereof.

In other preferred embodiments, the polymer component comprises one or more polymers, preferably curable polymers, selected from the group consisting of epoxy prepolymers, polyolefins, olefin acrylate copolymers and/or olefin methacrylate copolymers, olefin acrylate terpolymers and/or olefin methacrylate terpolymers, olefin elastomers, acrylate prepolymers or monomers, urethane prepolymers and mixtures thereof.

In a preferred embodiment, the thermally expandable composition exhibits a volume expansion at 180° C.
within the range of from about 50 to 1310 vol.-%, preferably of about 200±100 vol.-%, or 300±100 vol.-%, or 400±100 vol.-%, or 500±100 vol.-%, or 600±100 vol.-%, or 700±100 vol.-%, or 800±100 vol.-%, or 900±100 vol.-%, or 1000±100 vol.-%, or 1100±100 vol.-%, or 1200±100 vol.-%;
within the range of from about 1350 to 1900 vol.-%, preferably of about 1450±100 vol.-%, or 1550±100 vol.-%, or 1650±100 vol.-%, or 1750±100 vol.-%, or 1800±100 vol.-%; or
within the range of from about 1950 to 2800 vol.-%, preferably of about 2050±100 vol.-%, or 2150±100 vol.-%, or 2250±100 vol.-%, or 2350±100 vol.-%, or 2450±100 vol.-%, or 2550±100 vol.-%, or 2650±100 vol.-%;
in each case relative to the volume of the expandable composition prior to expansion.

In a preferred embodiment, the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide.

In another preferred embodiment, the weight content of azodicarbonamide is at least about 8.40 wt.-%, preferably at least about 8.60 wt.-%, and more preferably at least about 8.80 wt.-%, relative to the total weight of the thermally expandable composition.

In another preferred embodiment, the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition.

In another preferred embodiment, the weight content of the tackifier is at least about 6.5 wt.-%, preferably at least about 7.0 wt.-%, more preferably at least about 8.5 wt.-%, and still more preferably at least about 10 wt.-%, relative to the total weight of the thermally expandable composition.

In another preferred embodiment, the weight content of the filler is at least about 11 wt.-%, preferably at least about 13 wt.-%, and more preferably at least about 15 wt.-%, relative to the total weight of the thermally expandable composition.

In another preferred embodiment, the weight ratio of azodicarbonamide to the metal oxide powder is
within the range of from about 5.0 to 31, preferably of from about 10 to 31, more preferably of from about 15 to 31, and still more preferably of from about 16.50, preferably about 17 to 31;
within the range of from about 34 to 82; or
within the range of from about 85 to 100.

In another preferred embodiment, the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; preferably, the total content of one or more peroxides is at most about 4.50 wt.-%, more preferably at most about 4.00 wt.-%, still more preferably at most about 3.50 wt.-%, yet more preferably at most 3.00 wt.-%, even more preferably at most 2.75 wt.-%, most preferably at most about 2.50 wt.-%, and in particular at most about 2.25 wt.-%, in each case relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the weight content of the tackifier is at least about 6.5 wt.-%, preferably at least about 7.0 wt.-%, more preferably at least about 8.5 wt.-%, and still more preferably at least about 10 wt.-%, relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the weight content of the filler is at least about 11 wt.-%, preferably at least about 13 wt.-%, and more preferably at least about 15 wt.-%, relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the weight content of azodicarbonamide is at least about 8.40 wt.-%, preferably at least about 8.60 wt.-%, and more preferably at least about 8.80 wt.-%, relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide; and/or
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition.

In another preferred embodiment,
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the weight content of the tackifier is at least about 6.5 wt.-%, preferably at least about 7.0 wt.-%, more preferably at least about 8.5 wt.-%, and still more preferably at least about 10 wt.-%, relative to the total weight of the thermally expandable composition.

In another preferred embodiment,
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the weight content of the filler is at least about 11 wt.-%, preferably at least about 13 wt.-%, and more preferably at least about 15 wt.-%, relative to the total weight of the thermally expandable composition.

In another preferred embodiment,
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the weight content of azodicarbonamide is at least about 8.40 wt.-%, preferably at least about 8.60 wt.-%, and more preferably at least about 8.80 wt.-%, relative to the total weight of the thermally expandable composition.

In another preferred embodiment,
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
the weight content of the tackifier is at least about 6.5 wt.-%, preferably at least about 7.0 wt.-%, more preferably at least about 8.5 wt.-%, and still more preferably at least about 10 wt.-%, relative to the total weight of the thermally expandable composition.

In another preferred embodiment,
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
the weight content of the filler is at least about 11 wt.-%, preferably at least about 13 wt.-%, and more preferably at least about 15 wt.-%, relative to the total weight of the thermally expandable composition.

In another preferred embodiment,
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
the weight content of azodicarbonamide is at least about 8.40 wt.-%, preferably at least about 8.60 wt.-%, and more preferably at least about 8.80 wt.-%, relative to the total weight of the thermally expandable composition.

In another preferred embodiment,
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100; and/or
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0; and/or
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof.

In another preferred embodiment,
the weight content of the metal oxide powder is at most about 0.50 wt.-%, relative to the total weight of the thermally expandable composition; preferably the weight content of the metal oxide powder is at most about 0.50 wt.-%, relative to the total weight of the thermally expandable composition and the metal oxide powder comprises or essentially consists of zinc oxide;
the weight content of azodicarbonamide is at least about 8.40 wt.-%, preferably at least about 8.60 wt.-%, and more preferably at least about 8.80 wt.-%, relative to the total weight of the thermally expandable composition;
the weight ratio of azodicarbonamide to the metal oxide powder is within the range of from about 5.0 to 31, preferably of from about 10 to 31, more preferably of from about 15 to 31, and still more preferably of from about 16.50, preferably about 17 to 31; or within the range of from about 34 to 82; or within the range of from about 85 to 100;
the molar ratio of azodicarbonamide to the polymerization initiator (e.g. peroxide) is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0 or at least about 30.5; more preferably at least about 31.0, still more preferably at least about 31.5, yet more preferably at least about 32.0;
the polymer component comprises one or more polymers, preferably curable polymers, selected from the group consisting of polyolefins, olefin acrylate copolymers and/or olefin methacrylate copolymers, olefin acrylate terpolymers and/or olefin methacrylate terpolymers, olefin vinylacetate copolymers, olefin elastomers and mixtures thereof, and/or
the weight content of the polymerization initiator (e.g. peroxide) is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition.

In a preferred embodiment, the thermally expandable composition according to the invention either comprises no peroxide, preferably no polymerization initiator at all, or, when it comprises a polymerization initiator, preferably peroxide,
(i) the weight content of the polymerization initiator, preferably peroxide, is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
(ii) the molar ratio of azodicarbonamide to the total weight of the polymerization initiator, preferably peroxide, is greater than about 30.0, preferably at least about 30.5, more preferably at least about 31.0, still more preferably at least about 31.5, yet more preferably at least about 32.0.

Preferably, the weight content of the metal oxide powder is at most about 0.50 wt.-%, preferably at most about 0.45 wt.-%, more preferably at most about 0.40 wt.-%, still more preferably at most about 0.35 wt.-%, yet more preferably at most about 0.30 wt.-%, even more preferably at most about 0.25 wt.-%, most preferably at most about 0.20 wt.-%, and in particular at most about 0.15 wt.-%, relative to the total weight of the thermally expandable composition.

In a particularly preferred embodiment of the invention, particularly when the thermally expandable composition is a noise reducing foam, cavity filler or sealant, the thermally expandable composition comprises, in each case relative to the total weight of the thermally expandable composition, (i) 35 to 85 wt.-%, preferably 40 to 80 wt.-% of a polymer component comprising or essentially consisting of a polyolefin, olefin acrylate copolymer and/or olefin methacrylate copolymer, olefin acrylate terpolymer and/or olefin methacrylate terpolymer, olefin vinylacetate copolymer, olefin elastomer or a mixture thereof, preferably a mixture of one or more olefin vinylacetate copolymers with one or more olefin acrylate copolymers and/or olefin methacrylate copolymers, optionally together with one or more olefin acrylate terpolymers and/or olefin methacrylate terpolymers; more preferably a mixture of one or more ethylene vinylacetate copolymers with one or more ethylene alkyl acrylate copolymers, optionally together with one or more ethylene alkyl acrylate terpolymers;
(ii) 2.0 to 16 wt.-%, preferably 4.0 to 13 wt.-% azodicarbonamide;
(iii) 0.01 to 2.0 wt.-%, preferably 0.03 to 1.0 wt.-%, more preferably 0.03 to 0.50 wt.-% metal oxide powder; preferably selected from zinc oxide, magnesium oxide, calcium oxide, iron oxide and mixtures thereof, more preferably zinc oxide;
(iv) 0.15 to 1.3 wt.-%, preferably 0.25 to 1.0 wt.-% of a curing agent for the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof, preferably selected from multifunctional acrylate and methacrylate esters and allyl containing cyanurates and isocyanurates;
(v) 0.4 to 4.5 wt.-%, preferably 0.8 to 3.5 wt.-% of a radical initiator; preferably peroxide; more preferably selected from n-butyl 4,4 bis t-butyl peroxy valerate, dibenzoyl peroxide, 2,5-dimethyl-2,5-bis(tert-butyl peroxy) hexane, 2,5-dimethyl-2,5-bis(tert-butyl peroxy) hexyne-3, di-tert-butyl peroxide, tert-butyl cumyl peroxide, di-cumyl peroxide, bis(tert-butyl peroxy isopropyl)benzene, and 1,1-di-tert-butyl peroxy-3,3,5-trimethylcyclohexane;
(vi) optionally, 11 to 31 wt.-%, preferably 11 to 21 wt.-% of at least one filler; preferably selected from carbonates, calcium carbonate, feldspars, micas, quartz, silica, diatomaceous earth, vermiculite, pyrophyllite, sauconite, saponite, nontronite, montmorillonite, glass, clay, talc, ammonium chloride, dimethyl ammonium chloride, dimethyl benzyl ammonium chloride, titanium dioxide, pigments, colorants, glass beads or bubbles, glass, carbon or ceramic fibers, nylon aramid or polyamide fibers, and mixtures thereof,
(vii) optionally, 2.0 to 20 wt.-%, preferably 5.0 to 15 wt.-% of at least one tackifier; preferably a hydrocarbon based tackifier; more preferably an aromatically modified C5 or C5:C9 hydrocarbon tackifying resin or an aliphatic resin;
wherein the weight ratio of the azodicarbonamide to the metal oxide powder is at least about 5.0 and at most about 80; preferably at least about 5.0 and at most about 30; more preferably at least about 16.50, preferably about 17 and at most about 30.

Preferably, the ratio of the difference value of azodicarbonamide weight content minus metal oxide powder weight content to the polymerization initiator weight content (e.g. peroxide eight content) (i.e. ([azodicarbonamide wt.-%]-[metal oxide powder wt.-%])/[polymerization initiator wt.-%], all percentages relative to the total weight of the composition) is
at least about 1.85, preferably at least about 2.00, more preferably at least about 2.25, still more preferably at least about 2.40, yet more preferably at least about 2.75, even more preferably at least about 3.00, most preferably at least about 4.00, and in particular at least about 4.25;
at most about 8.00, preferably at most about 7.75, more preferably at most about 7.50, still more preferably at most about 7.25, yet more preferably at most about 7.00, even more preferably at most about 6.75, most preferably at most about 6.50, and in particular at most about 6.25; and/or
within the range of from about 2.00±0.50, or 2.50±1.00, or 2.50±0.50, or 3.00±1.50, or 3.00±1.00, or 3.00±0.50, or 3.50±2.00, or 3.50±1.50, or 3.50±1.00, or 3.50±0.50, or 4.00±2.50, or 4.00±2.00, or 4.00±1.50, or 4.00±1.00, or 4.00±0.50, or 4.50±3.00, or 4.50±2.50, or 4.50±2.00, or 4.50±1.50, or 4.50±1.00, or 4.50±0.50, or 5.00±3.50, or 5.00±3.00, or 5.00±2.50, or 5.00±2.00, or 5.00±1.50, or 5.00±1.00, or 5.00±0.50.

Preferably, the difference value of the ratio of azodicarbonamide weight content and polymerization initiator weight content (e.g. peroxide weight content) minus metal oxide powder weight content (i.e. ([azodicarbonamide wt.-%]/[polymerization initiator wt.-%]) -[metal oxide powder wt.-%], all percentages relative to the total weight of the composition) is
at least about 1.75, preferably at least about 2.00, more preferably at least about 2.20, still more preferably at least about 2.40, yet more preferably at least about 2.80, even more preferably at least about 3.20, most preferably at least about 3.60, and in particular at least about 4.00;
at most about 8.00, preferably at most about 7.75, more preferably at most about 7.50, still more preferably at most about 7.25, yet more preferably at most about 7.00, even more preferably at most about 6.75, most preferably at most about 6.50, and in particular at most about 6.25; and/or
within the range of from about 2.00±0.50, or 2.50±1.00, or 2.50±0.50, or 3.00±1.50, or 3.00±1.00, or 3.00±0.50, or 3.50±2.00, or 3.50±1.50, or 3.50±1.00, or 3.50±0.50, or 4.00±2.50, or 4.00±2.00, or 4.00±1.50, or 4.00±1.00, or 4.00±0.50, or 4.50±3.00, or 4.50±2.50, or 4.50±2.00, or 4.50±1.50, or 4.50±1.00, or 4.50±0.50, or 5.00±3.50, or 5.00±3.00, or 5.00±2.50, or 5.00±2.00, or 5.00±1.50, or 5.00±1.00, or 5.00±0.50.

Preferably, the molar ratio of azodicarbonamide to the polymerization initiator is at least about 16.0, preferably at least about 17.0, more preferably at least about 18.0, still more preferably at least about 20.0, yet more preferably at least about 22.0, even more preferably at least about 24.0, most preferably at least about 27.0, and in particular greater than about 30.0, preferably at least 30.5; more preferably at least about 31.0, still more preferably at least about 31.5, yet more preferably at least about 32.0; contrary to WO 2019/134842 A1, which teaches that compositions with a molar ratio of azodicarbonamide to polymerization initiator of more than 30 suffer from high odor formation as well as high ammonia emission.

Preferably, the weight ratio of azodicarbonamide to the metal oxide powder is at least about 10, preferably at least about 11, more preferably at least about 12, still more preferably at least about 13, yet more preferably at least about 14, even more preferably at least about 15, most preferably at least about 16, and in particular at least about 16.50, preferably about 17. Preferably, the weight ratio of azodicarbonamide to the metal oxide powder is at least about 17, preferably at least about 18, more preferably at least about 19, still more preferably at least about 20, yet more preferably at least about 21, even more preferably at least about 22, most preferably at least about 16, and in particular at least about 23.

In preferred embodiments of the thermally expandable composition according to the invention
the thermally expandable composition either comprises no peroxide, preferably no polymerization initiator at all, or, when it comprises a polymerization initiator, preferably peroxide, (i) the weight content of the polymerization initiator, preferably peroxide, is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or (ii) the molar ratio of azodicarbonamide to the total weight of the polymerization initiator, preferably peroxide, is greater than about 30.0, preferably at least about 30.5, more preferably at least about 31.0, still more preferably at least about 31.5, yet more preferably at least about 32.0; and/or
the weight content of the metal oxide powder is at most about 0.50 wt.-%, relative to the total weight of the thermally expandable composition; and/or
the weight ratio of azodicarbonamide to the metal oxide powder is at least about 16.50, preferably about 17 and preferably at most about 30.

In preferred embodiments
the thermally expandable composition either comprises no peroxide, preferably no polymerization initiator at all, or, when it comprises a polymerization initiator, preferably peroxide, (i) the weight content of the polymerization initiator, preferably peroxide, is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or (ii) the molar ratio of azodicarbonamide to the total weight of the polymerization initiator, preferably peroxide, is greater than about 30.0, preferably at least about 30.5, more preferably at least about 31.0, still more preferably at least about 31.5, yet more preferably at least about 32.0; and
the weight content of the metal oxide powder is at most about 0.50 wt.-%, relative to the total weight of the thermally expandable composition; and
the weight ratio of azodicarbonamide to the metal oxide powder is at least about 16.50, preferably about 17 and preferably at most about 30.

The thermally expandable composition according to the invention releases at most about 80 ppm ammonia, preferably at most about 50 ppm ammonia, still more preferably at most about 40 ppm ammonia, yet more preferably at most about 30 ppm ammonia, even more preferably at most about 20 ppm ammonia upon determination of the odor characteristics according to VDA 270.

The thermally expandable composition of the invention may be used in various applications including but not limited to automotive industry, aircraft industry, building and construction industry.

The thermally expandable composition of the invention may be used with any substrate and may be used as sealant or as adhesive for the bonding together of a range of substrates. For example the thermally expandable composition may be used to bond together metal substrates such as in automobile manufacture. It may be used in the bonding of different substrates such as the bonding of metal to fiber reinforced composites. It may be used for the bonding of glass such as in windows and automobile windscreens.

Another aspect of the invention relates to a substrate provided with a coating of a thermally expandable composition according to the invention. Preferably, the substrate according to the invention comprises metal and/or polymers. The substrate may also be an organo sheet material or a composite material. Preferably, the substrate according to the invention comprises an automobile component. The thickness of the substrate is not particularly limited and may vary with the application of the thermally expandable composition. Preferably, the substrate has a thickness of from about 500 μm to about 10000 μm.

In another embodiment the thermally expandable composition may be of materials used for the production of seals and baffles in automobiles.

The invention may be used to create foams that assist in the reduction of vibration and noise after activation. In this regard, reinforced and vibrationally damped components can have increased stiffness which will reduce natural frequencies that resonate through the automotive chassis thereby reducing transmission, blocking or absorbing noise through the use of the conjunctive acoustic product.

By increasing the stiffness and rigidity of the components of a vehicle, the amplitude and frequency of the overall noise, vibration or both that occurs from the operation of the vehicle and is transmitted through the vehicle can be reduced. These foams usually have a higher degree of expansion than foamed structural adhesives, typically at least about 1000 vol.-%, or at least about 1500 vol.-%, or at least about 2000 vol.-%, relative to the volume of the thermally expandable composition before it was heated to the activation of expansion temperature.

Another aspect of the invention relates to a method for volume expansion of a thermally expandable composition according to the invention comprising the step of heating the thermally expandable composition to the activation of expansion temperature.

Another aspect of the invention relates to a method for curing a thermally expandable composition according to the invention comprising the step of heating the thermally expandable composition to the activation of cure temperature.

Another aspect of the invention relates to a method comprising the steps of combining all ingredients of the thermally expandable composition, shaping a part from the thermally expandable composition, expanding and curing the thermally expandable composition, preferably by applying heat.

Another aspect of the invention relates to a method comprising the steps of filling a cavity or sealing a cavity with the thermally expandable composition according to the invention by expanding the thermally expandable composition into said cavity, preferably by applying heat.

Another aspect of the invention relates to an article comprising a thermally expandable composition according to the invention, which was heated to its activation of expansion temperature and/or activation of cure temperature and subsequently cooled to room temperature.

Particularly preferred embodiments of the invention are compiled as clauses 1 to 52 hereinafter:

The following examples further illustrate the invention but are not to be construed as limiting its scope:

### General Operation Procedures:

The odor formation in terms of free ammonia was quantified as follows:

The sample preparation and storage conditions are realized according to VDA 270-A3. A sample of 10 g is entered into the 1L test vessel. The test vessel is closed and stored in a preheated oven at 80° C. for 2h. Then, the test vessel is removed from the thermal chamber and cool down to 50° C. prior to evaluation.

The air inside the test vessel is pumped into ammonia reactive tubes and the value of ammonia amount is read immediately.

Average volume expansion was measured using this method:

The uncured material volume Vi of at least 3 samples (25×25×3 mm) was determined by obtaining its weight in air and water using a specific gravity balance. The uncured material was baked (20 minutes at 190° C.) and the material volume V2 was determined by obtaining its weight in air and water using a specific gravity balance. The % volume change was obtained using the equation: [(V2-V1)/V1]×100.

### Example 1 (epoxy prepolymers)

Thermally expandable compositions were prepared from the following ingredients:

| Commercial name | Chemical structure and name |
|---|---|
| Kukdo KD214C | solid epoxy resin |
| Kukdo KD242G | solid epoxy resin |
| Kukdo YD128 | liquid epoxy resin |
| Dyhard UR400 | urea |
| Dyhard 100S | dicyandiamide |
| Lotryl20MA08 | copolymer ethylene methylacrylate |
| Talc | talc |
| LSA01 | carboxyl terminated butadiene acrylonitrile |
| | rubber (CTBN)-epoxy adduct |
| Extra R | zinc oxide (2 μm) |
| Inovox SG | calcium oxide (38 μm) |
| Magnesium Oxide | magnesium oxide (15 μm) |
| Cellcom AC7000DB | azodicarbonamide |

All ingredients were weighed and mixed with one another at room temperature yielding the following thermally expandable compositions:

| [wt.-%] | | | | | | | | |
|---|---|---|---|---|---|---|---|---|
| Commercial name | 1-1 | 1-2 | 1-3 | 1-4 | 1-5 | 1-6 | 1-7 | 1-8 |
| Kukdo KD214C | 10.38 | 10.38 | 10.38 | 10.38 | 10.38 | 10.38 | 10.38 | 10.38 |
| Kukdo KD242G | 12.43 | 12.43 | 12.43 | 12.43 | 12.43 | 12.43 | 12.43 | 12.43 |
| Kukdo YD128 | 12.00 | 12.00 | 12.00 | 12.00 | 12.00 | 12.00 | 12.00 | 12.00 |
| Dyhard UR400 | 0.50 | 0.50 | 0.50 | 0.50 | 0.50 | 0.50 | 0.50 | 0.50 |
| Dyhard 100S | 2.00 | 2.00 | 2.00 | 2.00 | 2.00 | 2.00 | 2.00 | 2.00 |
| Lotryl20MA08 | 5.50 | 5.50 | 5.50 | 5.50 | 5.50 | 5.50 | 5.50 | 5.50 |
| Talc | 39.64 | 39.59 | 39.49 | 38.69 | 39.64 | 36.69 | 39.64 | 36.69 |
| LSA01 | 15.00 | 15.00 | 15.00 | 15.00 | 15.00 | 15.00 | 15.00 | 15.00 |
| Extra R | 0.05 | 0.10 | 0.20 | 1.00 | — | — | — | — |
| Inovox SG | — | — | — | — | 0.05 | 3.00 | — | — |
| Magnesium Oxide | — | — | — | — | — | — | 0.05 | 3.00 |
| Cellcom AC7000DB | 2.50 | 2.50 | 2.50 | 2.50 | 2.50 | 2.50 | 2.50 | 2.50 |
| molar ratio (ADCA:ZnO) | 35.0 | 17.5 | 8.8 | 1.8 | — | — | — | — |
| weight ratio (ADCA:ZnO) | 50.0 | 25.0 | 12.5 | 2.5 | — | — | — | — |
| molar ratio (ADCA:CaO) | — | — | — | — | 24.1 | 0.4 | — | — |
| weight ratio (ADCA:CaO) | — | — | — | — | 50.0 | 0.8 | — | — |
| molar ratio (ADCA:MgO) | — | — | — | — | — | — | 17.4 | 0.3 |
| weight ratio (ADCA:MgO) | — | — | — | — | — | — | 50.0 | 0.8 |
| Ammonia (ppm) | 5 | 10 | 40 | 40 | 10 | 100 | 15 | 45 |
| % volume expansion | 670 | 692 | 691 | 897 | 653 | 503 | 649 | 443 |
| (20 min at 190° C.) | | | | | | | | |

As demonstrated by a comparison of examples 1-1 to 1-4 with one another (metal oxide powder=ZnO), when increasing the weight ratio of ADCA:ZnO from 2.5 (example 1-4) to 50.0 (example 1-1), the release of ammonia is steadily reduced from 40 ppm to ppm. The analogous trend is demonstrated by examples 1-5 to 1-6 (metal oxide powder=CaO), as well as examples 1-7 to 1-8 (metal oxide powder=MgO). However, when the weight ratio of ADCA metal oxide powder becomes too high, foamability is deteriorated (ZnO: 897->670), i.e. the desired catalytic effect of the metal oxide powder does not sufficiently evolve. Therefore, in order to achieve a balanced ammonia release at acceptable foamability, the weight ratio ADCA: metal oxide powder needs to be properly adjusted.

### Example 2 (EVA prepolymer)

Thermally expandable compositions were prepared from the following ingredients:

| Commercial name | Chemical structure and name |
|---|---|
| Evatane 2805 | ethylene vinyl acetate copolymer |
| Evatane 18-150 | ethylene-vinyl acetate copolymer |
| Lotryl35BA40 | ethylene butylacrylate copolymer |
| Elvaloy 4170P | ethylene butylacrylate terpolymer |
| SR399 | dipentaerythritol pentaacrylate 50-70% |
| Luperox 230XL40 | n-butyl 4,4 bis t-butyl peroxy valerate |
| Omya BL | calcium carbonate (filler) |
| Hikotack P110S | petroleum hydrocarbon resin (tackifier) |
| Black pearl | carbon black |
| Unifoam AZ1035 | azodicarbonamide |
| Extra R | zinc oxide (2 μm) |
| Inovox SG | calcium oxide (38 μm) |
| Magnesium Oxide | magnesium oxide (15 μm) |

All ingredients were weighed and mixed with one another at room temperature yielding the following thermally expandable compositions:

| [wt.-%] | | | | | | | | | | | | | |
|---|---|---|---|---|---|---|---|---|---|---|---|---|---|
| Commercial name | 2-0 | 2-1 | 2-2 | 2-3 | 2-4 | 2-1a | 2-2a | 2-5 | 2-6 | 2-7 | 2-8 | 2-9 | 2-10 |
| Evatane 2805 | 15.00 | 15.00 | 15.00 | 15.00 | 15.00 | 15.00 | 15.00 | 15.00 | 15.00 | 15.00 | 15.00 | 15.00 | 15.00 |
| Evatane 18-150 | 6.00 | 6.00 | 6.00 | 6.00 | 6.00 | 6.00 | 6.00 | 6.00 | 6.00 | 6.00 | 6.00 | 6.00 | 6.00 |
| Lotryl35BA40 | 35.00 | 35.00 | 35.00 | 35.00 | 35.00 | 35.00 | 35.00 | 35.00 | 35.00 | 35.00 | 35.00 | 35.00 | 35.00 |
| Elvaloy 4170P | 6.00 | 6.00 | 6.00 | 6.00 | 6.00 | 6.00 | 6.00 | 6.00 | 6.00 | 6.00 | 6.00 | 6.00 | 6.00 |
| SR399 | 0.55 | 0.55 | 0.55 | 0.55 | 0.55 | 0.55 | 0.55 | 0.55 | 0.55 | 0.55 | 0.55 | 0.55 | 0.55 |
| Luperox 230XL40 | 2.00 | 2.00 | 2.00 | 2.00 | 2.00 | 4.60 | 4.60 | 2.00 | 2.00 | 2.00 | 2.00 | 2.00 | 2.00 |
| Omya BL | 16.15 | 16.05 | 15.85 | 15.65 | 15.25 | 13.45 | 13.25 | 16.05 | 15.85 | 15.25 | 16.05 | 15.25 | 13.25 |
| Hikotack P110S | 10.00 | 10.00 | 10.00 | 10.00 | 10.00 | 10.00 | 10.00 | 10.00 | 10.00 | 10.00 | 10.00 | 10.00 | 10.00 |
| Black pearl | 0.20 | 0.20 | 0.20 | 0.20 | 0.20 | 0.20 | 0.20 | 0.20 | 0.20 | 0.20 | 0.20 | 0.20 | 0.20 |
| Unifoam AZ1035 | 9.00 | 9.00 | 9.00 | 9.00 | 9.00 | 9.00 | 9.00 | 9.00 | 9.00 | 9.00 | 9.00 | 9.00 | 9.00 |
| Extra R | 0.10 | 0.20 | 0.40 | 0.60 | 1.00 | 0.20 | 0.40 | — | — | — | — | — | — |
| Inovox SG | — | — | — | — | — | — | — | 0.20 | 0.40 | 1.00 | — | — | — |
| Magnesium Oxide | — | — | — | — | — | — | — | — | — | — | 0.20 | 1.00 | 3.00 |
| molar ratio | 0.5 | 1.0 | 2.1 | 3.1 | 5.1 | 0.45 | 0.9 | — | — | — | — | — | — |
| (Zn:PE) | | | | | | | | | | | | | |
| molar ratio | 21.4 | 16.0 | 10.6 | 7.9 | 5.3 | 9.7 | 7.4 | — | — | — | — | — | — |
| (ADCA:(PE + Zn)) | | | | | | | | | | | | | |
| molar ratio | 63.1 | 31.6 | 15.8 | 10.5 | 6.3 | 31.6 | 15.8 | — | — | — | — | — | — |
| (ADCA:ZnO) | | | | | | | | | | | | | |
| weight ratio | 90.0 | 45.0 | 22.5 | 15.0 | 9.0 | 45.0 | 22.5 | — | — | — | — | — | — |
| (ADCA:ZnO) | | | | | | | | | | | | | |
| molar ratio (Ca:PE) | — | — | — | — | — | — | — | 1.5 | 3.0 | 7.5 | — | — | — |
| molar ratio | — | — | — | — | — | — | — | 13.0 | 8.1 | 3.8 | — | — | — |
| (ADCA:(PE + Ca)) | | | | | | | | | | | | | |
| molar ratio | — | — | — | — | — | — | — | 21.7 | 10.9 | 4.4 | — | — | — |
| (ADCA:CaO) | | | | | | | | | | | | | |
| weight ratio | — | — | — | — | — | — | — | 45.0 | 22.5 | 9.0 | — | — | — |
| (ADCA:CaO) | | | | | | | | | | | | | |
| molar ratio (Mg:PE) | — | — | — | — | — | — | — | — | — | — | 2.1 | 10.4 | 31.2 |
| molar ratio | — | — | — | — | — | — | — | — | — | — | 10.5 | 2.8 | 1.0 |
| (ADCA:(PE + Mg)) | | | | | | | | | | | | | |
| molar ratio | — | — | — | — | — | — | — | — | — | — | 15.6 | 3.1 | 1.0 |
| (ADCA:MgO) | | | | | | | | | | | | | |
| weight ratio | — | — | — | — | — | — | — | — | — | — | 45.0 | 9.0 | 3.0 |
| (ADCA:MgO) | | | | | | | | | | | | | |
| Ammonia (ppm) | 5 | 5 | 10 | 25 | 100 | 5 | 6 | 12 | 10 | 110 | 25 | 25 | 300 |
| % volume expansion | 1688 | 2123 | 2306 | 2309 | 2387 | 1792 | 1904 | 1024 | 1484 | 1373 | 1118 | 1135 | 1272 |
| (20 min at 190° C.) | | | | | | | | | | | | | |
| % volume expansion | n.d. | 1292 | 1788 | 1978 | 2145 | n.d. | n.d. | n.d. | n.d. | n.d. | n.d. | n.d. | n.d. |
| (30 min at 165° C.) | | | | | | | | | | | | | |

PE = peroxide;
n.d. = not determined; ¹

As demonstrated by a comparison of examples 2-0 to 2-4 with one another (metal oxide powder=ZnO), when increasing the weight ratio of ADCA:ZnO from 9.0 (example 2-4) to 90.0 (example 2-0), the release of ammonia is steadily reduced from 100 ppm to 5 ppm. The analogous trend is demonstrated by examples 2-5 to 2-7 (metal oxide powder=CaO), as well as examples 2-8 to 2-10 (metal oxide powder=MgO). However, when the weight ratio of ADCA:metal oxide powder becomes too high, foamability is deteriorated (ZnO: 2387%->1688%; CaO: 1373%->1024%; MgO: 1272%->1118%). Additionally, when the weight ratio of ADCA:metal oxide powder becomes too high, the activation temperature of ADCA is not sufficiently lowered, i.e. the desired catalytic effect of the metal oxide powder does not sufficiently evolve, and foamability at lower temperatures is significantly deteriorated (ZnO: 2145%->1292%). Therefore, in order to achieve a balanced ammonia release at acceptable foamability, the weight ratio ADCA: metal oxide powder needs to be properly adjusted.

Further, as demonstrated by a comparison of examples 2-1 and 2-2 with examples 2-la and 2-2a, respectively, when increasing the amount of peroxide from 2.0 wt.-% (examples 2-1 and 2-2) to 4.6 wt.-% (examples 2-la and 2-2a) and thereby lowering the molar ratio of ADCA:PE from 32.4 (examples 2-1 and 2-2) to 14.1(examples 2-la and 2-2a), foamability is deteriorated (examples 2-1 and 2-la: 2123%->1792%; examples 2-2 and 2-2a: 2306%->1904%). A comparison of examples 2-la and 2-2a with one another confirms the trend; when the weight ratio of ADCA:ZnO becomes too high, foamability is deteriorated (1904%->1792%), i.e. the desired catalytic effect of the metal oxide powder does not sufficiently evolve.

The above experimental data indicate that the advantageous effect of the ADCA/metal oxide ratio exists for compositions comprising epoxy resins as well as for compositions comprising mixtures of polyolefins with ethylene alkyl (meth)acrylate copolymers as predominant polymeric constituent.

Further, the data demonstrate that a consistent trend can be observed for different metal oxides (ZnO, CaO, MgO).

FIG. 1 illustrates the influence of ADCA/ZnO ratio on ammonia formation.

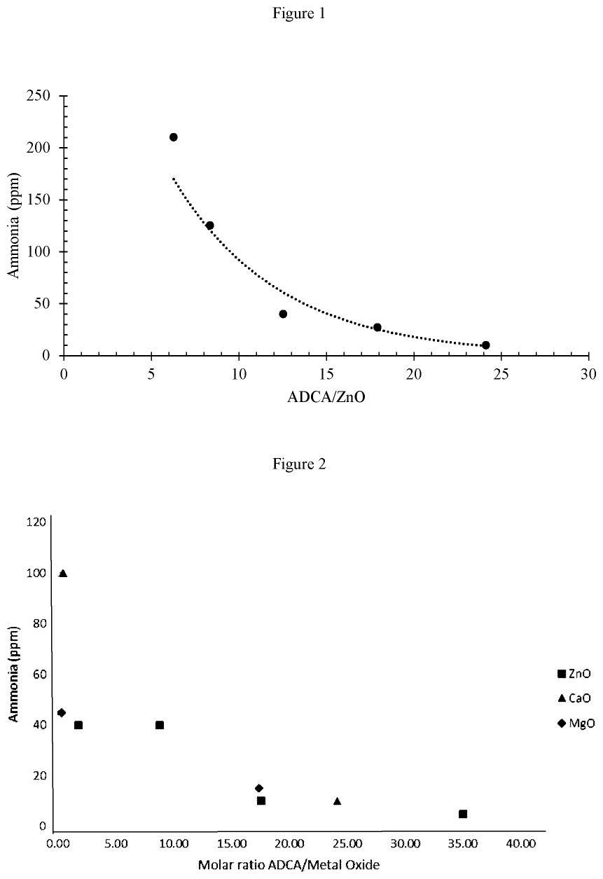

FIG. 2 illustrates the influence of ADCA/metal oxide ratio on ammonia formation in epoxy based foams at an ADCA content of 2.5 wt.-% (metal oxides: ZnO (▪), CaO (▴), MgO (♦)).

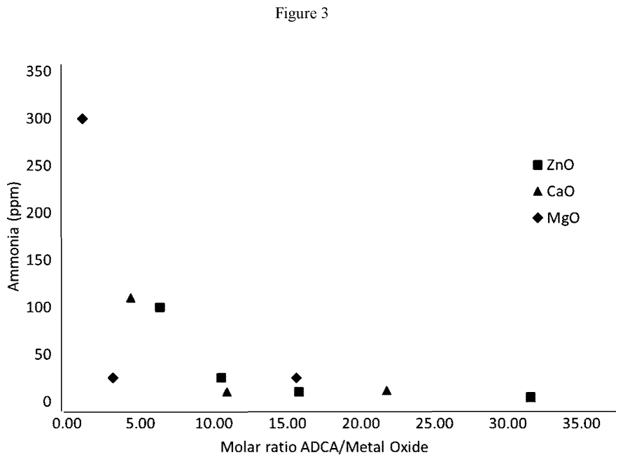

FIG. 3 illustrates the influence of ADCA/metal oxide ratio on ammonia formation in EVA based foams at an ADCA content of 9.0, wt.-% (metal oxides: ZnO (▪), CaO (▴), MgO (♦)). Absolute ammonia concentrations in FIG. 3 are higher than in FIG. 2 due to the higher absolute concentration of ADCA (9.0 wt.-% vs. 2.5 wt.-%).

1. A thermally expandable composition comprising
(i) a polymer component; preferably comprising or essentially consisting of (a) an epoxy prepolymer; or (b) an olefin acrylate copolymer and/or olefin methacrylate copolymer, an olefin acrylate terpolymer and/or olefin methacrylate terpolymer, an olefin vinylacetate copolymer, or a mixture thereof;
(ii) azodicarbonamide; and
(iii) a metal oxide powder capable of catalyzing thermal decomposition of azodicarbonamide at elevated temperature, wherein at least about 90 wt.-% of particles within the metal oxide powder have a particle size of at most about 200 μm determined by sieve analysis;
wherein the weight ratio of the azodicarbonamide to the metal oxide powder is at least about 5.0; preferably at least about 5.0 and at most about 80, more preferably at least about 5.0 and at most about 30, still more preferably at least about 16.50 and at most about 30, yet more preferably at least about 17 and at most about 30.

2-7. (canceled)

8. The thermally expandable composition according to claim 1, wherein the weight content of the metal oxide powder is at least about 0.03 wt.-%, preferably at least about 0.04 wt.-%, more preferably at least about 0.05 wt.-%, still more preferably at least about 0.06 wt.-%, yet more preferably at least about 0.07 wt.-%, even more preferably at least about 0.08 wt.-%, most preferably at least about 0.09 wt.-%, and in particular at least about 0.1 wt.-%; in each case relative to the total weight of the thermally expandable composition.

9-13. (canceled)

14. The thermally expandable composition according to claim 8, wherein the metal oxide is selected from zinc oxide, magnesium oxide, calcium oxide, iron oxide and mixtures thereof.

15-29. (canceled)

30. The thermally expandable composition according to claim 1, wherein the weight content of the azodicarbonamide is at least about 0.5 wt.-%, preferably at least about 1.0 wt.-%, more preferably at least about 1.5 wt.-%, still more preferably at least about 2.0 wt.-%, yet more preferably at least about 2.5 wt.-%, even more preferably at least about 3.0 wt.-%, most preferably at least about 3.5 wt.-%, and in particular at least about 4.0 wt.-%; in each case relative to the total weight of the thermally expandable composition.

31-32. (canceled)

33. The thermally expandable composition according to claim 1, wherein the polymer component comprises or essentially consists of a curable polymer, a non-curable polymer, a crosslinked polymer, a non-crosslinked polymer, or any mixture thereof.

34. (canceled)

35. The thermally expandable composition according to claim 33, wherein the weight content of the polymer component is at least about 36 wt.-%, preferably at least about 38 wt.-%, more preferably at least about 40 wt.-%, still more preferably at least about 42 wt.-%, yet more preferably at least about 44 wt.-%, even more preferably at least about 46 wt.-%, 3 most preferably at least about 48 wt.-%, and in particular at least about 50 wt.-%; in each case relative to the total weight of the thermally expandable composition.

36-37. (canceled)

38. The thermally expandable composition according to claim 1, wherein the thermally expandable composition comprises at least one filler.

39-44. (canceled)

45. The thermally expandable composition according to claim 8, wherein the thermally expandable composition exhibits a volume expansion at 190° C. of at least about 160 vol.-%, preferably at least about 200 vol.-%, more preferably at least about 240 vol.-%, still more preferably at least about 280 vol.-%, yet more preferably at least about 320 vol.-%, even more preferably at least about 360 vol.-%, most preferably at least about 400 vol.-%, and in particular at least about 440 vol.-%; in each case relative to the volume of the expandable composition prior to expansion.

46. The thermally expandable composition according to claim 8, wherein the thermally expandable composition exhibits a volume expansion at 190° C. of at most about 2750 vol.-%, preferably at most about 2700 vol.-%, more preferably at most about 2650 vol.-%, still more preferably at most about 2600 vol.-%, yet more preferably at most about 2550 vol.-%, even more preferably at most about 2500 vol.-%, most preferably at most about 2450 vol.-%, and in particular at most about 2400 vol.-%; in each case relative to the volume of the expandable composition prior to expansion.

47. The thermally expandable composition according to claim 8, wherein the thermally expandable composition exhibits a volume expansion at 190° C. of within the range of from about 100±50 vol.-%, or 200±100 vol.-%, or 400±200 vol.-%, or about 600±200 vol.-%, or 800±400 vol.-%, or 800±200 vol.-%, or 1000±600 vol.-%, or 1000±400 vol.-%, or 1000±200 vol.-%, or 1200±800 vol.-%, or 1200±600 vol.-%, or 1200±400 vol.-%, or 1200±200 vol.-%, or 1400±1000 vol.-%, or 1400±800 vol.-%, or 1400±600 vol.-%, or 1400±400 vol.-%, or 1400±200 vol.-%, or 1600±1200 vol.-%, or 1600±1000 vol.-%, or 1600±800 vol.-%, or 1600±600 vol.-%, or 1600±400 vol.-%, or 1600±200 vol.-%; in each case relative to the volume of the expandable composition prior to expansion.

48-50. (canceled)

51. The thermally expandable composition according to claim 1, wherein the polymer component comprises or essentially consists of an epoxy prepolymer.

52-56. (canceled)

57. The thermally expandable composition according to claim 51, which comprises a curing agent for the epoxy prepolymer.

58-64. (canceled)

65. The thermally expandable composition according to claim 51, wherein the thermally expandable composition comprises, in each case relative to the total weight of the thermally expandable composition,
(i) 20 to 50 wt.-%, preferably 25 to 45 wt.-% of a polymer component comprising or essentially consisting of an epoxy prepolymer; preferably a diglycidylether of a bisphenol; preferably a mixture of one or more solid epoxy prepolymers with one or more liquid epoxy prepolymers;
(ii) 0.5 to 10 wt.-%, preferably 1.0 to 5.0 wt.-% azodicarbonamide;
(iii) 0.01 to 2.0 wt.-%, preferably 0.03 to 1.0 wt.-%, more preferably 0.03 to 0.15 wt.-% metal oxide powder; preferably selected from zinc oxide, magnesium oxide, calcium oxide, iron oxide and mixtures thereof; more preferably zinc oxide;
(iv) 0.1 to 5.0 wt.-%, preferably 0.6 to 3.5 wt.-% of a curing agent for the epoxy prepolymer; preferably selected from the group consisting of dicyandiamide, aliphatic or aromatic amines or their respective adducts, amidoamines, polyamides, cycloaliphatic amines, anhydrides, polycarboxylic polyesters, isocyanates, phenol-based resins, modified and unmodified poly-amines or polyamides; more preferably dicyandiamide;
(v) optionally, 21 to 61 wt.-%, preferably 31 to 51 wt.-% of at least one filler; preferably selected from carbonates, calcium carbonate, feldspars, micas, quartz, silica, diatomaceous earth, vermiculite, pyrophyllite, sauconite, saponite, nontronite, montmorillonite, glass, clay, talc, ammonium chloride, dimethyl ammonium chloride, dimethyl benzyl ammonium chloride, titanium dioxide, pigments, colorants, glass beads or bubbles, glass, carbon or ceramic fibers, nylon aramid or polyamide fibers, and mixtures thereof; and
(vi) optionally, 4.0 to 30 wt.-% of an impact modifier; preferably a polymer/elastomer adduct; more preferably a carboxyl terminated butadiene acrylonitrile rubber (CTBN)-epoxy adduct;
wherein the weight ratio of the azodicarbonamide to the metal oxide powder is at least about 5.0 and at most about 80; preferably at least about 5.0 and at most about 70; more preferably at least about 5.0 and at most about 30; still more preferably at least about 16.50, preferably about 17 and at most about 30.

66-72. (canceled)

73. The thermally expandable composition according to claim 51, wherein the polymer component comprises or essentially consists of a mixture of one or more olefin vinylacetate copolymers with one or more olefin acrylate copolymers and/or olefin methacrylate copolymers, optionally together with one or more olefin acrylate terpolymers and/or olefin methacrylate terpolymers.

74-90. (canceled)

91. The thermally expandable composition according to claim 73, wherein the thermally expandable composition comprises, in each case relative to the total weight of the thermally expandable composition,
(i) 35 to 85 wt.-%, preferably 40 to 80 wt.-% of a polymer component comprising or essentially consisting of a polyolefin, olefin acrylate copolymer and/or olefin methacrylate copolymer, olefin acrylate terpolymer and/or olefin methacrylate terpolymer, olefin vinylacetate copolymer, olefin elastomer or a mixture thereof; preferably a mixture of one or more olefin vinylacetate copolymers with one or more olefin acrylate copolymers and/or olefin methacrylate copolymers, optionally together with one or more olefin acrylate terpolymers and/or olefin methacrylate terpolymers; more preferably a mixture of one or more ethylene vinylacetate copolymers with one or more ethylene alkyl acrylate copolymers, optionally together with one or more ethylene alkyl acrylate terpolymers;
(ii) 2.0 to 16 wt.-%, preferably 4.0 to 13 wt.-% azodicarbonamide;
(iii) 0.01 to 2.0 wt.-%, preferably 0.03 to 1.0 wt.-%, more preferably 0.03 to 0.50 wt.-% metal oxide powder; preferably selected from zinc oxide, magnesium oxide, calcium oxide, iron oxide and mixtures thereof; more preferably zinc oxide;
(iv) 0.15 to 1.3 wt.-%, preferably 0.25 to 1.0 wt.-% of a curing agent for the polyolefin, olefin acrylate copolymer and/or olefin methacrylate copolymer, olefin acrylate terpolymer and/or olefin methacrylate terpolymer, olefin vinylacetate copolymer, olefin elastomer or mixture thereof; preferably selected from multifunctional acrylate and methacrylate esters and allyl containing cyanurates and isocyanurates;
(v) 0.4 to 4.5 wt.-%, preferably 0.8 to 3.5 wt.-% of a radical initiator; preferably peroxide; more preferably selected from n-butyl 4,4 bis t-butyl peroxy valerate, dibenzoyl peroxide, 2,5-dimethyl-2,5-bis(tert-butyl peroxy) hexane, 2,5-dimethyl-2,5-bis(tert-butyl peroxy) hexyne-3, di-tert-butyl peroxide, tert-butyl cumyl peroxide, di-cumyl peroxide, bis(tert-butyl peroxy isopropyl)benzene, and 1,1-di-tert-butyl peroxy-3,3,5-trimethylcyclohexane;
(vi) optionally, 11 to 31 wt.-%, preferably 11 to 21 wt.-% of at least one filler; preferably selected from carbonates, calcium carbonate, feldspars, micas, quartz, silica, diatomaceous earth, vermiculite, pyrophyllite, sauconite, saponite, nontronite, montmorillonite, glass, clay, talc, ammonium chloride, dimethyl ammonium chloride, dimethyl benzyl ammonium chloride, titanium dioxide, pigments, colorants, glass beads or bubbles, glass, carbon or ceramic fibers, nylon aramid or polyamide fibers, and mixtures thereof;
(vii) optionally, 2.0 to 20 wt.-%, preferably 5.0 to 15 wt.-% of at least one tackifier; preferably a hydrocarbon based tackifier; more preferably an aromatically modified C5 or C5:C9 hydrocarbon tackifying resin or an aliphatic resin;
wherein the weight ratio of the azodicarbonamide to the metal oxide powder is at least about 5.0 and at most about 80; preferably at least about 5.0 and at most about 30; more preferably at least about 16.50, preferably about 17 and at most about 30.

92-96. (canceled)

97. The thermally expandable composition according to claim 51 either comprises no peroxide, preferably no polymerization initiator at all, or, when it comprises a polymerization initiator, preferably peroxide,
(i) the weight content of the polymerization initiator, preferably peroxide, is at most about 4.5 wt.-%, preferably at most about 4.0 wt.-%, more preferably at most about 3.5 wt.-%, still more preferably at most about 3.0 wt.-%, or at most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
(ii) the molar ratio of azodicarbonamide to the total weight of the polymerization initiator, preferably peroxide, is greater than about 30.0, preferably at least about 30.5, more preferably at least about 31.0, still more preferably at least about 31.5, yet more preferably at least about 32.0.

98-103. (canceled)

104. The thermally expandable composition according to claim 51,
wherein the weight content of the metal oxide powder is at most about 0.50 wt.-%, relative to the total weight of the thermally expandable composition;
wherein the weight ratio of azodicarbonamide to the metal oxide powder is at least about 16.50, preferably about 17 and preferably at most about 30; and
wherein the thermally expandable composition either comprises no peroxide, preferably no polymerization initiator at all, or, when it comprises a polymerization initiator, preferably peroxide,
(i) the weight content of the polymerization initiator, preferably peroxide, is at most about 4.5 wt.-%, preferably at most about 4.0 wt.-%, more preferably at most about 3.5 wt.-%, still more preferably at most about 3.0 wt.-%, or at 9 most about 2.75 wt.-%, yet more preferably at most about 2.5 wt.-%, even more preferably at most about 2.0 wt.-%, most about preferably at most about 1.5 wt.-%, and in particular at most about 1.0 wt.-%, relative to the total weight of the thermally expandable composition; and/or
(ii) the molar ratio of azodicarbonamide to the total weight of the polymerization initiator, preferably peroxide, is greater than about 30.0, preferably at least about 30.5, more preferably at least about 31.0, still more preferably at least about 31.5, yet more preferably at least about 32.0.

105. A method for volume expansion of a thermally expandable composition according to claim 1, comprising the step of heating the thermally expandable composition to the activation of expansion temperature.

106. A method for curing a thermally expandable composition according to claim 1, comprising the step of heating the thermally expandable composition to the activation of cure temperature.

107. An article comprising a thermally expandable composition according to claim 1, which was heated to its activation of expansion temperature and/or activation of cure temperature and subsequently cooled to room temperature.
